(19) United States
(12) Patent Application Publication
(10) Pub. No.: US 2017/0199770 A1
(43) Pub. Date: Jul. 13, 2017

(54) CLOUD HOSTING SYSTEMS FEATURING SCALING AND LOAD BALANCING WITH CONTAINERS

(71) Applicant: GetClouder Ltd., Sofia (BG)

(72) Inventors: Dima Peteva, Sofia (BG); Mariyan Marinov, Sofia (BG)

(21) Appl. No.: 15/321,186

(22) PCT Filed: Jun. 22, 2015
(86) PCT No.: PCT/EP2015/064007

§ 371 Date: Dec. 21, 2016

Related U.S. Application Data
(60) Provisional application No. 62/016,029, filed on Jun. 23, 2014.
(60) Provisional application No. 62/016,036, filed on Jun. 23, 2014.

(51) Int. Cl. G06F 9/50

(52) U.S. Cl. CPC G06F 9/5088; G06F 9/505; G06F 2209/5022

(57) ABSTRACT

The present disclosure describes methods and systems for load balancing of a host-computing device. A supervisory computing device receives one or more resource usage statistics (e.g., CPU, memory, disk storage, and network bandwidth) of container instances operating on a first host-computing device. The device determines whether (i) the resource usage statistics of each of the containers, which are linked a given user account, exceeds (ii) a set of threshold values associated with the given user account. Responsive to the determination that the compared resource usage statistics exceeds a given threshold value, the device transmits a command (e.g., API function) to the first host computing device to migrate the container associated with the compared resource usage statistics from the first host computing device to a second host computing device selected from a group of host computing devices. The migration occurs with a guaranteed minimum downtime of the web-services being provided by the container.

### RELATED APPLICATIONS

The present application claims priority to and/or the benefit of U.S. Application No. 62/016,029, titled “Load Balancing Systems and Methods for Cloud Hosting Systems With Containers,” and filed Jun. 23, 2014; and 62/016,036, titled “Cloud Hosting Systems With Automatic Scaling Containers,” and filed Jun. 23, 2014. The contents of each of these applications are hereby incorporated herein by reference in their entireties.

### TECHNICAL FIELD

The present disclosure relates generally to systems and methods for managing distributed computing resources. More particularly, in certain embodiments, the present disclosure relates to load balancing and scaling methods and systems for cloud hosting systems with containers.

### BACKGROUND

Cloud hosting systems provide computing resources for companies and users to deploy and manage their software applications and data storage remotely in a cloud infrastructure. These applications and data storage services are often provided as web-based services for usage by the public and private end users. Typical cloud infrastructures consist of interconnected nodes of computing devices, typically servers, that host computing resources for such applications and data storage. Each of the host computing devices may be partitioned into multiple independently-operating instances of computing nodes, which are isolated from other instances of computing nodes residing on a common hardware of the computing devices.

Containers are instances of such servers that provide an operating-system level isolation and use the operating system's native system call interface. Thus, containers do not employ emulation or simulation of the underlying hardware (e.g., as with VMWare® ESXi) nor employ similar, but not identical, software interfaces to those of virtual machines (e.g., as with Citrix® Xen).

Existing load balancing and scaling methods improve the efficiency and performance of distributed computing resources by allocating the workload and end-user usages among the interconnected physical computing resources to prevent any given resource (e.g., of a host computing device) and the connectivity with such resources from being overloaded. However, such methods are implemented using multiple containers in order to share the workload and usage.

Moreover, to provide reliable services to the end-users, redundant or standby servers are often employed. Failover allows for the automatic switching of computing resources from a failed or failing computing device to a healthy (e.g., functional) one, thereby providing continuous availability of the interconnected resources to the end-user. Existing systems often maintain a duplicate computing resource-running copies of the software applications and data storage to provide such redundancy.

There is a need therefore for load balancing and scaling with container-based isolation that improves the density of host accounts for a given set of physical computing resources. There is also a need to provide more efficient failover operations.

### SUMMARY

In general overview, described herein are load balancing and scaling operations for cloud infrastructure systems that provide hosting services using container-based isolation. The cloud hosting systems of the present disclosure provide automatic live resource scaling operations that automatically add or remove computing capability (e.g., hardware resources) of container instances running on a given host-computing device. The target container can scale up its allotment of computing resource on the physical computing device without any downtime and can scale down with minimum availability interruption. The scaling operation allows for improved customer account density for a given set of computing resources in that a smaller number of physical computing resources are necessary to provide the equivalent level of functionality and performance for the same or higher number of customers. Hosting services of the present disclosure are thus more cost-effective and have lower environmental impact (e.g., less hardware correlates with less energy consumption).

Also presented herein is a method and system for live migration of containers among the host computing devices. The systems of the present disclosure guarantee that a minimum downtime is involved to provide high availability of such resources. To this end, any tasks running on the container instance are not interrupted and are automatically resumed once migrated. The live migration operation is beneficially coupled with node monitoring to provide seamless failover operations when an anomalous or unhealthy behavior is detected with a given physical computing device of the cloud hosting systems.

In certain embodiments, the present disclosure further allows for instant and scheduled scaling that provides the users (e.g., the hosting account owners, managers, and/or administrators) with the ability to instantly change the resource limits of a container and/or to configure scaling events based on a user-defined schedule (year, date and time). To this end, the present disclosure provides great flexibility to customers (i.e., users) to tailor and/or “fine tune” their accounts to maximize the usage of their hosted services. As used herein, users and customers refer to developers and companies that have a host service account, and end-users refer to clients of the users/customers that use the application and storage services being hosted as part of the user's hosted services.

In certain embodiments, the present disclosure provides capabilities to auto-scale available computing resources on-demand up to resource limits of a container. In some implementations, the system allows the user to increase the resource availability based on a schedule provided by the user.

In one aspect, the present disclosure describes a method of load balancing of a host-computing device. The method includes receiving, via a processor of a supervisory computing device (e.g., central server), one or more resource usage statistics (e.g., CPU, memory, disk storage, and network bandwidth) of one or more containers operating on a first host-computing device. The first host computing device runs an operating system kernel having one or more sets of isolated process groups (e.g., namespaces, which are limited with cgroups). Each of the one or more sets of isolated process groups corresponds to each of the containers.

In some implementations, the method includes determining, via the processor, whether (i) the resource usage statistics of each of one or more containers linked to a given user account exceeds (ii) a first set of threshold values associated with the given user account.

In some implementations, the method includes, responsive to the determination that at least one of the compared resource usage statistics exceeds the first set of threshold values, transmitting, via the processor, a command (e.g., API function) to the first host computing device to migrate the container associated with the compared resource usage statistics from the first host computing device to a second host computing device selected from a group of host computing devices, wherein the command includes (i) an identifier of the compared container determined to be exceeding the first set of threshold values and (ii) an identifier of the second host computing device.

In some implementations, the second host computing device is selected, by the supervisory computing device, as a host computing device having available resources greater than the available resources of those among the group of host computing devices.

In some implementations, the migrated container is transferred to a pre-provisioned container on the second host-computing device. The pre-provisioned container may include an image having one or more applications and operating system that are identical to that of the transferred container. The second host-computing device may be selected, by the supervisory computing device, as a host computing device having a pre-provisioned container running the same image as the compared container.

In some implementations, the first host computing device compares, via a processor of the first host computing device, (i) an average of one or more resource usage statistics of each container operating on the first host computing device to (ii) a second set of threshold values (e.g., up-scaling threshold) associated with the given user account. Responsive to at least one of the averaged resource usage exceeding the second set of threshold values for a given container, the first host computing device may adjust one or more resource allocations of the given compared container to an elevated resource level (e.g., increased CPU, memory, disk storage, and/or network bandwidth) defined for the given user account.

Subsequent to the first host computing device adjusting the one or more resource allocations of the given compared container to the elevated resource level, the first host computing device may compare, via a processor of the first host computing device, (i) the average of one or more resource usage statistics of each container operating on the first host computing device to (ii) a third set of threshold values (e.g. down-scaling threshold) associated with the given user account. Responsive to the averaged resource usage being determined to be below the third set of threshold values for the given container, the first host computing device may adjust the one or more resource allocations of the given compared container to a level that is below the elevated resource level and not below an initial level defined in the given user account.

In another aspect, the present disclosure describes a method for migrating a container from a first host-computing device to a second host computing device (e.g., with guaranteed minimum downtime) while maintaining hosting of the web-services provided by the container. The method includes receiving, via a processor on a first host-computing device, a command to migrate a container from the first computing device to a second host computing device, the processor running an operating system kernel.

In some implementations, the method includes, responsive to the receipt of the command, instructing, via the processor, the kernel to store a state of one or more computing processes being executed within the container in a manner that the computing processes are subsequently resumed from the state (e.g., checkpoint). The state may be stored as state data.

In some implementations, the method includes transmitting, via the processor, first instructions to a storage device to create a storage block and to attach the storage block to the first host computing device over a network where the storage device is operatively linked to both the first host computing device and second host computing device via the network.

In some implementations, the method includes, responsive to the storage block being attached to the first host computing device, instructing, via the processor, the kernel to store one or more portions of the state data to the storage block, wherein a remaining portion of the state data is at least a pre-defined data size (e.g., a few KBytes or MBytes).

In some implementations, the method includes instructing, via the processor, the kernel to halt all computing processes associated with the container and instructing, via the processor, the kernel to store a remaining portion of the state data of the pre-defined data size in the storage block. The state data may be stored in an incremental manner.

In some implementations, the state data is stored in an incremental manner until a remaining portion of the state data defined by a difference between the a last storing instance and a penultimate storing instance is less than a pre-defined data size.

Responsive to the remaining portion of the state data being stored, the system may transmit, via the processor, second instructions to the storage device to detach the storage block from the first host computing device and to attach the storage block to the second host computing device. Subsequently, the system may transmit, via the processor, third instructions to the second host computing device where the third instructions include one or more files having network configuration information of the container of the first host computing device. Upon receipt of the third instructions, the second host computing device is configured to employ the received one or more configuration files to (i) establish the container at the second host computing device and (ii) to resume the state of the one or more computing processes of the container executing on the second host computing device using the attached state data.

In another aspect, the present disclosure describes a non-transitory computer readable medium having instructions stored thereon, where the instructions, when executed by a processor, cause the processor to receive one or more resource usage statistics (e.g., CPU, memory, disk storage, and network bandwidth) of one or more containers operating on a first host computing device. The first host computing device runs an operating system kernel having one or more sets of isolated process groups (e.g., namespace, which are limited with cgroups). Each of the one or more sets of isolated process groups corresponds to each of the containers.

The instructions, when executed, further cause the processor to determine whether (i) the resource usage statistics of each of one or more containers linked to a given user account exceeds (ii) a first set of threshold values associated with the given user account.

The instructions, when executed, further cause the processor to, responsive to the determination that at least one of the compared resource usage statistics exceeds the first set of threshold values, transmit a command (e.g., API function) to the first host computing device to migrate the container associated with the compared resource usage statistics from the first host computing device to a second host computing device selected from a group of host computing devices, wherein the command includes (i) an identifier of the compared container determined to be exceeding the first set of threshold values and (ii) an identifier of the second host computing device.

In some implementations, the second host computing device is selected, by the supervisory computing device, as a host computing device having available resources greater than the available resources of those among the group of host computing devices.

In some implementations, the migrated container is transferred to a pre-provisioned container on the second host-computing device. The pre-provisioned container may include an image having one or more applications and operating system that are identical to that of the transferred container. The second host-computing device may be selected, by the supervisory computing device, as a host computing device having a pre-provisioned container running the same image as the compared container.

In some implementations, the first host computing device compares, via a processor of the first host computing device, (i) an average of one or more resource usage statistics of each container operating on the first host computing device to (ii) a second set of threshold values (e.g., up-scaling threshold) associated with the given user account. Responsive to at least one of the averaged resource usage exceeding the second set of threshold values for a given container, the first host computing device may adjust one or more resource allocations of the given compared container to an elevated resource level (e.g., increased CPU, memory, disk storage, and/or network bandwidth) defined for the given user account.

Subsequent to the first host computing device adjusting the one or more resource allocations of the given compared container to the elevated resource level, the first host computing device may compare, via a processor of the first host computing device, (i) the average of one or more resource usage statistics of each container operating on the first host computing device to (ii) a third set of threshold values (e.g. down-scaling threshold) associated with the given user account. Responsive to the averaged resource usage being determined to be below the third set of threshold values for the given container, the first host computing device may adjust the one or more resource allocations of the given compared container to a level that is below the elevated resource level and not below an initial level defined in the given user account.

In another aspect, the present disclosure describes a non-transitory computer readable medium having instructions stored thereon, where the instructions, when executed by a processor, cause the processor to receive a command to migrate a container from the first computing device to a second host computing device, the processor running an operating system kernel.

The instructions, when executed, further cause the processor to, responsive to the receipt of the command, instruct the kernel to store a state of one or more computing processes being executed within the container in a manner that the computing processes are subsequently resumed from the state (e.g., checkpoint). The state may be stored as state data.

The instructions, when executed, further cause the processor to transmit first instructions to a storage device to create a storage block and to attach the storage block to the first host computing device over a network where the storage device is operatively linked to both the first host computing device and second host computing device via the network.

The instructions, when executed, further cause the processor to, responsive to the storage block being attached to the first host computing device, instruct the kernel to store one or more portions of the state data to the storage block, wherein a remaining portion of the state data is at least a pre-defined data size (e.g., a few KBytes or MBytes).

The instructions, when executed, further cause the processor to instruct the kernel to halt all computing processes associated with the container and instructing, via the processor, the kernel to store a remaining portion of the state data of the pre-defined data size in the storage block. The state data may be stored in an incremental manner.

In some implementations, the state data is stored in an incremental manner until a remaining portion of the state data defined by a difference between the a last storing instance and a penultimate storing instance is less than a pre-defined data size.

The instructions, when executed, further cause the processor to, responsive to the remaining portion of the state data being stored, transmit second instructions to the storage device to detach the storage block from the first host computing device and to attach the storage block to the second host computing device. Subsequently, the instructions, when executed, further cause the processor to transmit third instructions to the second host computing device where the third instructions include one or more files having network configuration information of the container of the first host computing device. Upon receipt of the third instructions, the second host computing device is configured to employ the received one or more configuration files to (i) establish the container at the second host computing device and (ii) to resume the state of the one or more computing processes of the container executing on the second host computing device using the attached state data.

In another aspect, the present disclosure describes a method for scaling resource usage of a host server. The method includes receiving, via a processor of a host computing device, one or more resource usage statistics of one or more containers operating on the host computing device. The host computing device runs an operating system kernel having one or more sets of isolated process groups (e.g., namespaces, which are limited with cgroups). Each of the one or more sets of isolated process groups corresponding to each of the one or more containers.

In some implementations, the method includes comparing, via the processor, (i) an average of one or more resource usage statistics of each of the one or more containers to (ii) a first set of threshold values associated with each given user account that is associated with the compared container.

In some implementations, the method includes, responsive to at least one of the averaged resource usage exceeding the first set of threshold values for a given compared container, adjusting one or more resource allocations of the given compared container by a level defined for the given user account. The adjustment of the resource allocations of the given compared container may include an update to the cgroup of the operating system kernel. The level may be based on an increment of resource units (e.g., CPU cores for processing resources, GBytes of RAM for memory resources, GBytes for network bandwidth, and/or GBytes of hard disk for data storage).

In some implementations, subsequent to the first host computing device adjusting the one or more resource allocations of the given compared container to the elevated resource level, the method includes comparing, via a processor of the first host computing device, (i) the average of one or more resource usage statistics of each container operating on the first host computing device to (ii) a third set of threshold values (e.g. down-scaling threshold) associated with the given user account. Responsive to the averaged resource usage being determined to be below the third set of threshold values for the given container, the method includes adjusting the one or more resource allocations of the given compared container to a level between the elevated resource level and an initial level defined in the given user account.

In some implementations, the method further includes comparing, via the processor, (i) an average of one or more resource usage statistics of each of the one or more containers to (ii) a second set of threshold values associated with the given user account that is associated with the given compared container. Then, responsive to at least one of the averaged resource usage exceeding the second threshold value for the given compared container, the method includes migrating the given compared container to one or more containers on two or more host computing devices in accordance with a user-defined scaling rule (e.g., 1:2 or 1:4 or more).

In some implementations, the migration includes the steps of: retrieving, via the processor, attributes of the compared container (e.g., CPU, memory, Block device/File system sizes); creating, via the processor, a snapshot of the compared container, the compared container hosting one or more web services where the snapshot includes an image of web service processes operating in the memory and kernel of the given compared container; causing, via the processor, a new volume to be created at each new host computing device of the two or more host computing devices; causing, via the processor, a new container to be created in each of the new volumes, wherein the new containers comprise the snapshot of the compared container; starting one or more web service processes of the snapshot in each of the new containers; stopping the one or more web services of the compared container; and transferring traffic from (i) the one or more web services of the compared container to (ii) one or more web services of the new container.

In another embodiment, the migration includes the steps of: retrieving, via the processor, attributes of the compared container (e.g., CPU, memory, Block device/File system sizes); creating, via the processor, a snapshot of the compared container, the compared container hosting one or more web services, wherein the snapshot comprises an image of processes operating in the memory and kernel of the compared container; causing, via the processor, a new container to be created in each of the new volumes and a load balancing container to be created in a load balance volume; causing, via the processor, each of the new container to be linked to the load balancing container, wherein the load balancing container is configured to monitor usage statistics among the new containers and adjust resource allocation of the new containers to be within a pre-defined threshold; stopping the one or more web services of the compared container; and transferring traffic from (i) the one or more web services of the compared container to (ii) one or more web services of the new container.

In some implementations, the method further includes causing, via the processor, a firewall service to be added to the one or more web services of the new container.

In another aspect, the present disclosure describes a non-transitory computer readable medium having instructions stored thereon, where the instructions, when executed by a processor, cause the processor to receive one or more resource usage statistics of one or more containers operating on the host-computing device. The host computing device runs an operating system kernel having one or more sets of isolated process groups (e.g., namespaces, which are limited with cgroups). Each of the one or more sets of isolated process groups corresponding to each of the one or more containers.

The instructions, when executed, further cause the processor to compare (i) an average of one or more resource usage statistics of each of the one or more containers to (ii) a first set of threshold values associated with each given user account that is associated with the compared container.

The instructions, when executed, further cause the processor to, responsive to at least one of the averaged resource usage exceeding the first set of threshold values for a given compared container, adjust one or more resource allocations of the given compared container by a level defined for the given user account. The adjustment of the resource allocations of the given compared container may include an update to the cgroup of the operating system kernel. The level may be based on an increment of resource units (e.g., CPU cores for processing resources, GBytes of RAM for memory resources, GBytes for network bandwidth, and/or GBytes of hard disk for data storage).

In some implementations, subsequent to the first host computing device adjusting the one or more resource allocations of the given compared container to the elevated resource level, the instructions, when executed, further cause the processor to compare (i) the average of one or more resource usage statistics of each container operating on the first host computing device to (ii) a third set of threshold values (e.g. down-scaling threshold) associated with the given user account. Responsive to the averaged resource usage being determined to be below the third set of threshold values for the given container, the instructions may cause the processor to adjust the resource allocations of the given compared container to a level between the elevated resource level and an initial level defined in the given user account.

The instructions, when executed, further cause the processor to compare (i) an average of one or more resource usage statistics of each of the one or more containers to (ii) a second set of threshold values associated with the given user account that is associated with the given compared container. Then, responsive to at least one of the averaged resource usage exceeding the second threshold value for the given compared container, the instructions, when executed, further cause the processor to migrate the given compared container to one or more containers on two or more host computing devices in accordance with a user-defined scaling rule (e.g., 1:2 or 1:4 or more).

In some implementations, the instructions, when executed, further cause the processor to create a snapshot of the compared container, the compared container hosting one or more web services where the snapshot includes an image of web service processes operating in the memory and kernel of the given compared container; cause a new volume to be created at each new host computing device of the two or more host computing devices; cause a new container to be created in each of the new volumes, wherein the new containers comprise the snapshot of the compared container; starting one or more web service processes of the snapshot in each of the new containers; stop the web services of the compared container; and transfer traffic from (i) the one or more web services of the compared container to (ii) one or more web services of the new container.

In another embodiment, the instructions, when executed, further cause the processor to retrieve attributes of the compared container (e.g., CPU, memory, Block device/File system sizes); create a snapshot of the compared container, the compared container hosting one or more web services, wherein the snapshot comprises an image of processes operating in the memory and kernel of the compared container; cause a new container to be created in each of the new volumes and a load balancing container to be created in a load balance volume; cause each of the new container to be linked to the load balancing container, wherein the load balancing container is configured to monitor usage statistics among the new containers and adjust resource allocation of the new containers to be within a pre-defined threshold; stopping the one or more web services of the compared container; and transfer traffic from (i) the one or more web services of the compared container to (ii) one or more web services of the new container. The instructions, when executed, further cause the processor to causing a firewall service to be added to the one or more web services of the new container.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a system diagram illustrating a container-based cloud hosting system, according to an illustrative embodiment of the invention.

FIG. 2 is a block diagram illustrating a container-based isolation, according to an illustrative embodiment of the invention.

FIG. 3 is a block diagram illustrating customer-side interface to the cloud hosting system, according to an illustrative embodiment of the invention.

FIG. 4 is a block diagram illustrating an example system for automatic load-balancing of host node resources, according to an illustrative embodiment of the invention.

FIG. 5 is a swim lane diagram illustrating container live-migration, according to an illustrative embodiment of the invention.

FIG. 6 is a block diagram illustrating an example system for automatic scaling of host node resources, according to an illustrative embodiment of the invention.

FIG. 7A is a graphical user interface for configuring user-defined account for hosting services, according to an illustrative embodiment of the invention.

FIG. 7B is a graphical user interface for configuring on-demand auto-scaling in a hosting service account, according to an illustrative embodiment of the invention.

FIG. 7C is a graphical user interface for configuring scheduled scaling in a hosting service account, according to an illustrative embodiment of the invention.

FIG. 7D is a graphical user interface for monitoring usages of hosting services, according to an illustrative embodiment of the invention.

FIGS. 8A and 8B are block diagrams illustrating selectable scaling options, according to an illustrative embodiment of the invention.

FIG. 9 is a flowchart of an example method for scaling a hosted computing account, according to an illustrative embodiment of the invention.

FIG. 10 is a block diagram of a method for container live-migration, according to an illustrative embodiment of the invention.

FIG. 11 is a flowchart of an example method to pre-provision a host computing device, according to an illustrative embodiment of the invention.

FIG. 12 is a flowchart of an example method for automatic update of the deployed containers, according to an embodiment of the invention.

FIG. 13 is a block diagram of another example network environment for creating software applications for computing devices.

FIG. 14 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

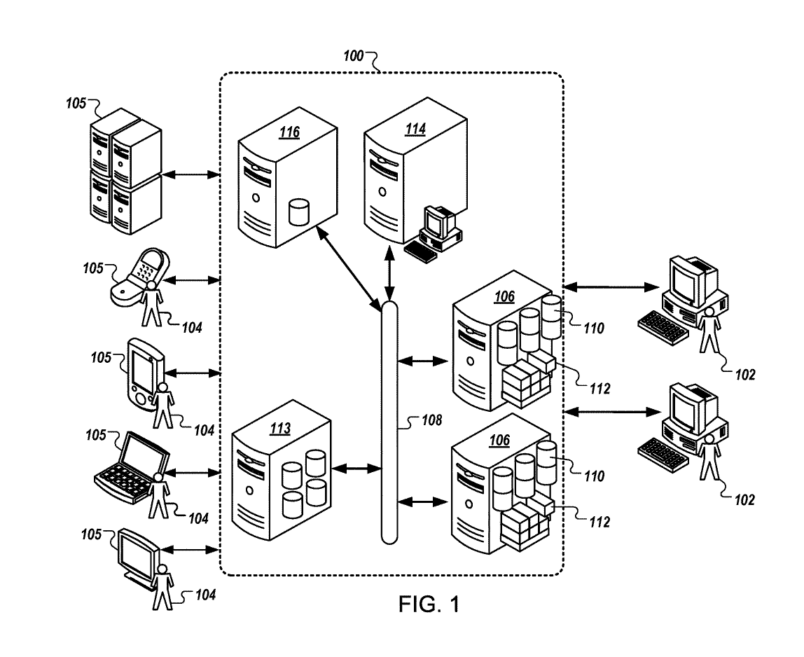

Described herein is a container-based cloud-hosting system and environment. FIG. 1 is a system diagram illustrating a container-based cloud hosting system 100, according to an illustrative embodiment of the invention. The cloud hosting system 100 provides leased computing resources for use by clients 102 to, for example, host websites and web-services (e.g., file hosting) accessible via the World Wide Web. End-users 104 may access the hosted websites and web-services via corresponding networked computing devices 105 (e.g., cellphone, tablets, laptops, personal computers, televisions, and various servers). The cloud hosting system 100 may be part of a data center that provides storage, processing, and connectivity capacity to the users of clients 102 (hereinafter “users,” “clients,” “users of clients” and/or “102”).

The cloud hosting system 100 includes a cluster of host computing devices 106 that are connected to one another, in certain implementations, over a local area network 108 or, in other implementations, over a wide area network 108, or a combination thereof. The host computing devices 106 provide the processing resources (e.g., CPU and RAM), storage devices (e.g., hard disk), and network throughput resources to be leased to the clients 102 to, for example, host the client's web services and/or web applications.

Each of the host computing devices 106 (or host nodes) includes instances of containers 112, which are linked to a given hosting user account of the client 102. Containers are classes, data structures, abstract data types or the like that, when instantiated, are used to collect and/or store objects in an organized manner. In some implementations, the containers 112 may partition the host-computing device 106 into respective units of resources (e.g., CPU core or RAM size) available for a given physical device. For example, the system 100 may assign individual CPUs (on a multicore system) for a given user account or assign/set limits of the actual usage of the CPUs (e.g., by percentage of available resources).

In some implementations, each of the host computing devices 106 includes distributed storage devices 110 that are shared among the containers 112 of each device 106. The distributed storage devices 110 include block devices that may mount and un-mount to provide disk space for the container file storage and for the container memory files. The distributed storage devices 110 may be directly accessible by the file system (e.g., of the computing devices 106) as a regular block storage device.

In some implementations, the host computing devices 106 connect, via the network 108, to a cluster of networked storage devices 113 that provide storage resources (e.g., disk storage) to be leased and/or made accessible to the clients 102. These networked storage resources may also be employed for the container file storage or the container memory files.

In some implementations, the container-based cloud hosting system 100 includes a central server 114 that supervises the resource usage statistics of each of the host nodes 106 as part of system's load balancing operation. Load balancing generally refers to the distribution of workloads across various computing resources, in order to maximize throughput, minimize response time and avoid overloading resources. The central server 114 is also referred to as a supervisory computing device. The load-balancing operation distributes the utilization of computing resources across all or a portion of the host nodes 106 to ensure a sufficient reserve of available resources on each of the host nodes 106.

In some implementations, the central server 114 monitors the resource usage of host nodes to determine whether the utilization by the physical computing device has exceeded a predefined limit of usage. When such excess conditions are detected, the central server 114 may reassign one or more containers of that host node to a less loaded host node among the host nodes 106 in the cluster. The resource usage may include, but is not limited to, the processing capacity that the physical device can provide, which can be determined as a function, in some implementations, of the number of CPU cores and CPU clock speed, the amount of RAM, and/or the storage installed. Such reassignment guidelines produce the long-term effect of large containers and/or hosting accounts having heavy resource utilization being assigned to a host node 106 with smaller containers and/or less utilized hosting accounts, thereby improving the density of the hosting user account among a smaller set of host nodes.

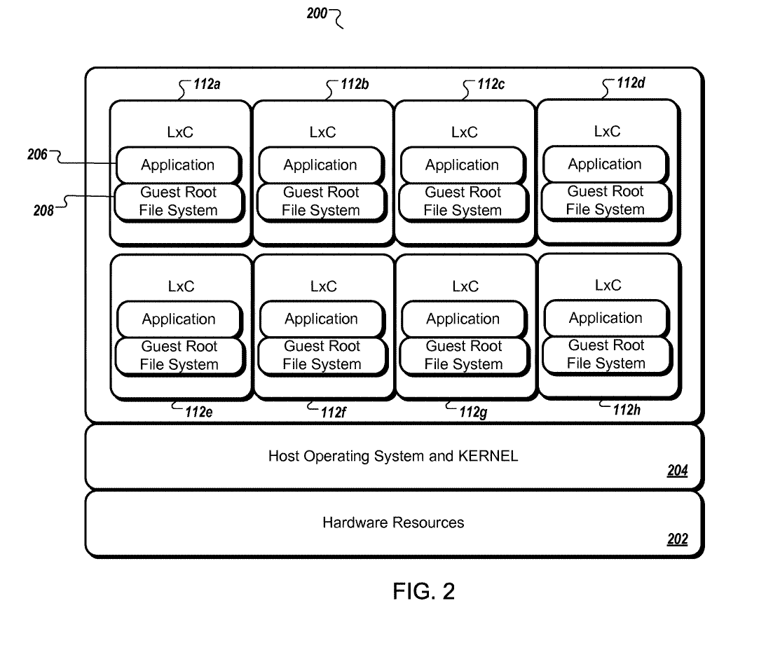

Turning now to FIG. 2, a block diagram illustrating a container-based isolation 200 is presented, according to an illustrative embodiment of the invention.

In FIG. 2, a container-based isolation 200 that employs LinuX Containers (LxC) is shown. Of course, other operating systems with container-based isolation may be employed. Isolation and separation of computing resources is done through the Linux namespaces in the host operating system kernel. The LinuX Containers are managed with various user space applications, and resource limitations are imposed using control groups (referred also as “cgroup”), which are part of the Linux operating system.

In the data model shown, the LinuX containers employ a Linux kernel and operating system 204, which operate on or with the hardware resources 202 of a given host node 106. One or more containers 112 (shown as containers 112a to 112h) use the underlying Linux kernel 204 for, among other things, CPU scheduling, memory management, namespace support, device drivers, networking, and security options. The host operating system 204 imposes resource limitations on one or more containers 112, shown as containers 112a to 112h. Examples of kernel features and their respective functions employed by the LinuX container are provided in Table 1.

TABLE 1

| Kernel Features | Function |
|---|---|
| Control Group Support | Freezer cgroup subsystem |
| | CPUset support |
| | CPU accounting cgroup subsystem |
| | Resource counters (e.g., memory resource |
| | controllers for the control groups) |
| Block device IO limits | Block device I/O limits |
| | Task/process limits |
| | Device limits |
| Group CPU Scheduler | Basis for grouping tasks (cgroup) |
| Namespaces Support | UTS namespace |
| | IPC namespace |
| | User namespace |
| | PID namespace |
| | Network namespace |
| Device Drivers | Character devices (support multiple |
| | instances of devpts) |
| | Network device support (e.g., MAC-VLAN |
| | support; and Virtual Ethernet pair device) |
| Networking | Networking options (e.g., 801.1d Ethernet |
| | Bridging) |
| Security Options | Operation system capabilities |
| | File System POSIX capabilities |

Each LinuX container 112 includes one or more applications 206 and a guest root file system 208 that comprises an operating system and a distribution of web-server and supporting applications. In some implementations, the cloud hosting system 100 receives an input from the user 102 of the operating system and distribution which are to be deployed and run on the container 112 for a given user account. Various Linux and Unix operating systems with similar functionality may be employed.

These operating systems and distribution can include, but not limited to “Joomla LaMp”, “Joomla nginx”; “WordPress nginx”, “WordPress LaMp”; “Centos LaMp”, “Centos nginx”, Centos Plain; “Ubuntu Trusty LaMp”, “Ubuntu Trusty LeMp”, “Ubuntu Trusty 14.04”; and “Debian Wheezy LeMp”, “Debian Wheezy LaMp”, and “Debian Wheezy Plain.” The LaMp configuration refers to a distribution of a Linux-based operating system loaded and/or configured with an Apache web server, a MySQL database server, and a programing language (e.g., PHP, Python, Perl, and/or Ruby) for dynamic web pages and web development. LeMp configuration refers to a Linux-based operating system loaded and/or configured with an NginX (namely “engine x”) HTTP web server, a MySQL database management server, and a programing language (e.g., PHP, Python, Perl, and/or Ruby). Other nomenclature, such as “Wheezy” and “Trusty” refers to stable and popular versions of the respective Linux or Unix distribution.

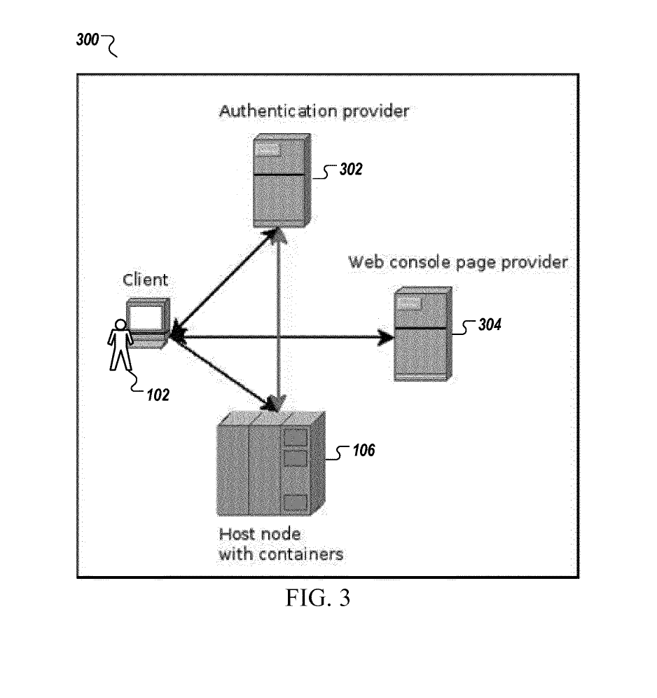

Turning now to FIG. 3, a block diagram illustrating a user-side interface 300 to the cloud hosting system 100 is presented, according to an illustrative embodiment of the invention. In some implementations, the users of clients 102 access their respective hosting accounts via a web console. The web console may consist of a HTML5-based application that uses WebSockets to connect to the respective container 112, which is linked to the user's account. The connection may be encrypted (although it may alternatively be unencrypted) or may be performed over a secure shell (SSH). In some implementations, Perl libraries may be employed for communication and message passing. The web console may be provided to an application of the users of the clients 102 by a web-console page-provider 304.

The cloud hosting system 100 may include an authentication server 302 to authenticate the users of the clients 102 and thereby provide access to the system 100. Once authenticated, the authentication server 302 may provide the user's web-client with a token that allows the user of the clients 102 to access the host nodes 106 directly.

To this end, each of the host nodes 106 may include a dispatcher application for accepting and verifying requests from the users of the clients 102. In some implementations, the dispatcher application executes and/or starts a bash shell within the user's container and configures the shell with the same privileges as the root user for that container. The executed and/or started bash shell may be referred to as Container console.

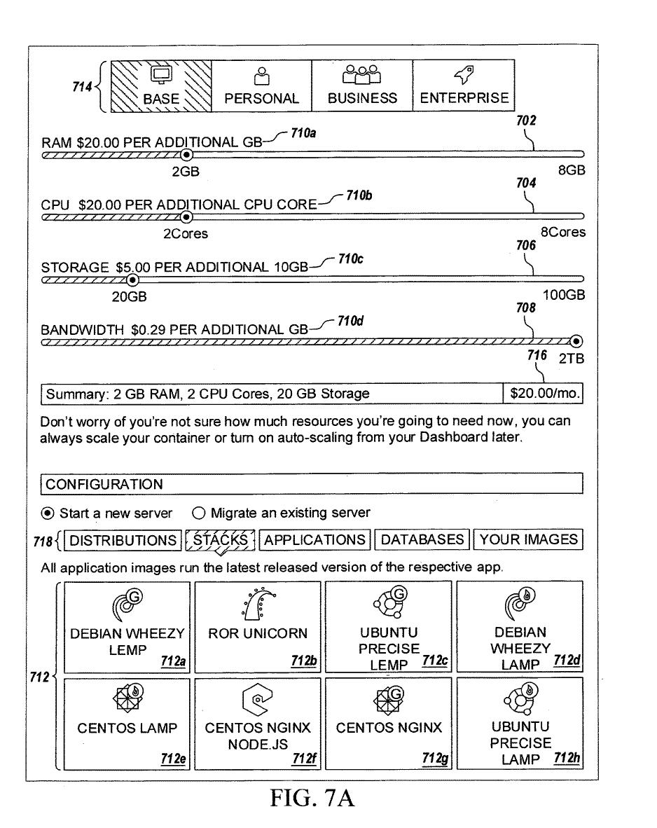

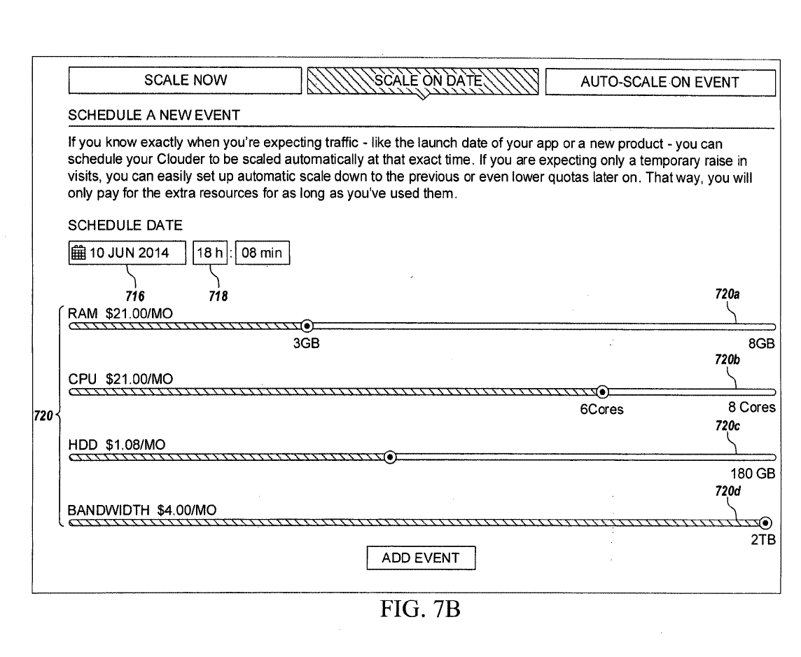

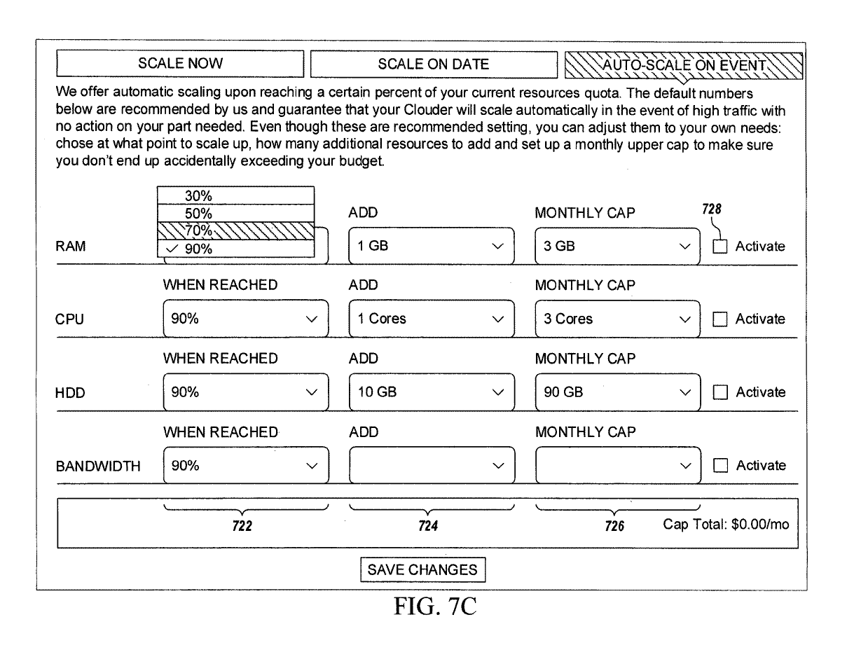

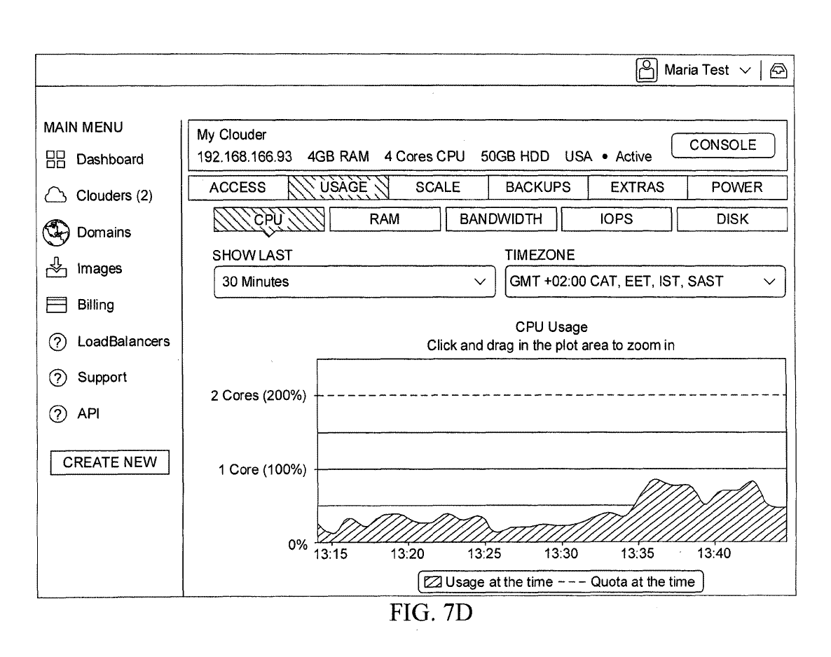

In some implementations, after the user has successfully logged into the hosting account, the container console (e.g., in FIGS. 7A-D) is presented to the users as a web console, via a web client running on the clients 102. The web console allows the users of the clients 102 to manage and track usage of their host account. After login, the web console may prompt the users of the clients 102 to choose a container 112 with which to establish a connection. Once selected, the web console may request connection information (e.g., IP address of the dispatcher application running on the connected host node and the port number to which the web console can connect, and/or an authentication token that was generated by the authentication server 302) from the connected host node.

In some implementations, when an authentication token is provided, the web client opens a WebSocket connection to the dispatcher application and sends requests with the authentication token as a parameter. The token allows for communication between the host node(s) and the user's web client without further authentication information being requested and/or required. In some implementations, the authentication token is generated by the authentication server, via HMAC (e.g., MD4 or SHAT), using the container name and/or identifier, the IP address of the client device of the user 102, the token creation time, and a secret key value.

Once the authentication token has been verified, the dispatching application may create a temporary entry in its database (DB) in which the entry maps the web client IP address with the associated container, the token creation time, and the last time that the token was updated with the actual token. The information may be used to determine whether re-authentication is necessary.

In some implementations, the web console includes a command line interface. The command line interface may capture keyboard inputs from clients 102 and transmit them to the dispatching application. The web console application may designate meanings for certain keys, e.g., ESC, CTRL, ALT, Enter, the arrow keys, PgUp, PgDown, Ins, Del or End, to control the mechanism in which the gathered keyboard input is transmitted to the dispatching application and to control the visualization of the received data in the command line interface. The web console may maintain a count of each key stroke to the command line and provide such information to the dispatching application. The various information may be transmitted after being compressed.

FIG. 7A is a graphical user interface 700 for configuring user-defined containers for hosting services, according to an illustrative embodiment of the invention. The user interface 700 provides an input for the user 102 to select, adjust and/or vary the hosting service for a given server and/or container, including the amount of memory 702 (e.g., in GBytes), the amount of CPU 704 (e.g., in number of CPU cores), the amount of hard disk storage 706 (e.g., in GBytes), and the network throughput or bandwidth 708 (e.g., in TBytes per month). The user interface 700 may present a cost breakdown 710a-d for each of the selections 702-708 (e.g., 710c, “$5.00 PER ADDITIONAL 10 GB”). The user interface 700 allows the user 102 to select a preselected set of resources of container 714 (e.g., base, personal, business, or enterprise). The selection may be input via buttons, icons, sliders, and the like, though other graphical widget representation may be employed, such as checklists, drop-down selections, knobs and gauges, and textual input.

Widget and/or section 716 of the user interface 700 displays summary information, for example, outlining the selections in the menus 702-708 and the corresponding cost (e.g., per month). It should be understood that widget 716 may be used to display additional summary information, including configurations to be used for and/or applied to new or existing servers.

As shown in FIG. 7, the user interface 700 allows the user 102 to select options to start a new server or to migrate an existing server, for example, by selecting corresponding radial buttons. Selecting the option to migrate an existing server results in the pre-installed OS, applications, and configurations of the existing server to continue to be used for and/or applied to the server. Using existing servers allows users to reproduce or backup servers or containers linked to their respective accounts, thereby providing greater flexibility and seamlessness in the hosting service for scaling and backing up existing services. In some example implementations, selecting the option to migrate an existing server causes the graphical user interface to display options to configure the server (including the migrated server).

Selecting the option to start a new server causes the user interface 700 to provide and/or display options (e.g., buttons) 718, for selecting distributions, stacks, applications, databases, and the like. In one example implementation displayed in FIG. 7A, the option to configure stacks is selected, causing the types of stacks available to be applied to the new server (712) to be displayed and/or provided via user interface 700. Examples of stacks to be applied to the new server include Debian Wheezy LEMP (712a), RoR Unicorn (712b), Ubuntu Precise LEMP (712c), Debian Wheezy LAMP (712d), Centos LAMP (712e), Centos Nginx NodeJS (712f), Centox Nginx (712g), and Ubuntu Precise LAMP (712h). Of course, it should be understood that other types of distributions, stacks, applications, databases and the like, to configure the new server, may be provided as options by the user interface 700 and selected by the user.

The options 718 also allows users to view preexisting images (e.g., stored in an associated system) and selected for the new server. For example, once a system is installed and configured according to the user's requirements, the users 102 can create a snapshot/image of the disk for that container. This snapshot can be later be used and or selected via the options 718 for provisioning new servers and/or containers, which would have identical (or substantially identical) data as the snapshot of the parent server and/or container (e.g., at the time the snapshot was created), thereby saving the user 102 time in not having to replicate previously performed actions. The snapshot can also be used as a backup of their Linux distribution and web applications of a given server and/or container instance.

### Load Balancing and Container Migration

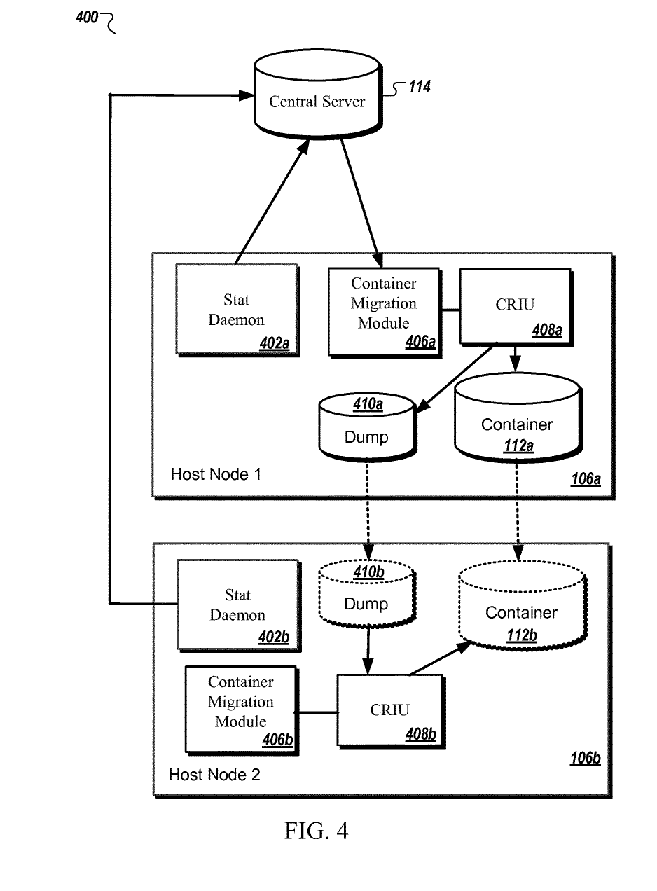

Turning now to FIG. 4, a block diagram 400 illustrating an example system for automatic load-balancing operations of host node resources is presented, according to an illustrative embodiment of the invention. The load-balancing service allows containers to be migrated from the host node to one or more host nodes or containers across a cluster of host nodes. This allows the host node to free resources (e.g., processing) when it is near its operational capacity.

In some implementations, the central server 114 compares (1) the average resources (e.g., via a moving average window) used by each host node 106, or (2) the average resources available (e.g., a moving averaged window) to a threshold established by the operator of the cloud hosting system 100.

Each host node 106 (e.g., host nodes 106a and 106b) may include a node resource monitor 402 (e.g., Stats Daemons 402a and 402b) that monitors the resource allocation of its corresponding host node, and collects statistical usage data for each container and the overall resource usage for the host node. The node resource monitor 402 may interface with the central server 114 to provide the central server 114 with the resource usage information to be used for the load-balancing operation. The resources being analyzed or monitored may be measured in CPU seconds, in RAM utilization (e.g., in KBytes, MBytes, or GBytes or in percentages of the total available RAM memory), in Storage utilization (e.g., in KBytes, MBytes, GBytes, or TBytes or in percentages of the total available storage), and in Bandwidth throughput (e.g., in KBytes, MBytes, or GBytes or in percentage of the total available bandwidth).

When the node resource monitor 402a (e.g., Stats Daemon) on the near-overloaded host node 106a determines that the average usages (or availability) of a given resource for that host node 106a exceed the respective upper or lower threshold of that resource, the node resource monitor 402 may identify the container instance (shown as container 112a) that is utilizing the biggest portion of that overloaded resource. The node resource monitor 402a may then report the name or identifier of that container instance (e.g., container 112a) to the central server 114 to initiate the migration of that container 112a to another host node.

In some implementations, the central server 114 selects a candidate host node 106b to which the reported container 112a is to be migrated. The selection may be based on a list of host nodes that the central server 114 maintains, which may be sorted by available levels of resources (e.g., CPU, RAM, hard-disk availability, and network throughput). In some implementations, once a candidate host node 106b has been selected, that host node 106b may be moved to a lower position in the list due to its updated available levels of resources. By using this action there is ability, which allows simultaneous container migrations to multiple host nodes, which lead and reduce the likelihood of a cascading overloading effect from multiple migration events being directed to a single host node.

In some implementations, the central server 114 connects to the candidate host node 106b and sends a request for resource usage information of the candidate host node 106b. The request may be directed to the node resource monitor 402 (shown as stat daemon 402b) residing on the candidate host node 106b.

The locality of the node resource monitor 402 allows for more frequent sampling of the resource usage information, which allows for the early and rapid detection (e.g., within a fraction of a second) of anomalous events and behaviors by the host node.

The node resource monitor 402 may maintain a database of usage data for its corresponding host node, as well as the resource requirements and container-specific configurations for that node. In some implementations, the database of usage data is accessed by the node resource monitor 402 to determine whether the respective host node has sufficient resources (e.g., near or reached the maximum CPU or memory capacity) for receiving a migrated container instance while still preserving some capacity to scale the container.

The database may be employed in a PostgreSQL Database server and Redis indexing for fast in memory key-value of the storage and/or database. Of course, other object-relational database management system (ORDBMS) may be employed, particularly those with replication capability of the database for security and scalability features. In some implementations, the database may be accessed via Perl DBD::Pg to access the PostgreSQL databases via Socket interfaces (e.g., Perl IO:: Socket::INET).

The central server 114 may compare the total available hardware resources provided by the stat daemon 402b of the candidate host node 106b in order to determine if the candidate host node 106b is suitable to host the migrating container 112a. If the central server 114 determines that the candidate host node 106b is not a suitable target for the migration, the central server 114 may select another host node (e.g., 106c (not shown)) from the list of host nodes.

In some implementations, the list includes each host node 106 in the cluster and/or sub-clusters. If the central server 114 determines that none of the host nodes 106 within the cluster and/or sub-clusters is suitable, then the central server 114 may interrupt the migration process and issue a notification to be reported to the operator of the system 100.

Upon the central server 114 determining that a candidate host node is a suitable target for the container migration, the central server 114 may connect to a container migration module 406 (shown as modules 406a and 406b) residing on the transferring host node 106a. A container migration module 406 may reside on each of the host nodes 106 and provide supervisory control of the migration process once a request is transmitted to it from the central server 114.

The container migration module 406 may coordinate the migration operation to ensure that the migration occurs automatically, transparent to the user, and with a guaranteed minimum down-time. In some implementations, this guaranteed minimum down-time is within a few seconds to less than a few minutes.

In some implementations, the container migration module 406 interfaces with a Linux tool to checkpoint and restore the operations of running applications, referred to as a Checkpoint/Restore In Userspace 408 (“CRIU 408”). The container migration module 406 may operate with the CRIU 408 to coordinate the temporary halting of tasks running on the transferring container instance 112a and the resuming of the same tasks from the transferred container instance (shown as container 112b) from the same state once the migration process is completed.

It is found that the minimum downtime may depend on the amount of the memory allocation of the transferring container instance 112a. For example, if the transferring container instance 112a is allocated 5 GB of memory, then the minimum time is dependent on the speed for the host node 106a dumping (e.g., transmitting) the 5 GB of memory data to temporary block storage, transferring them to the host node 106b and then restoring the dumped data in the memory of the transferred host node 106b. The minimum time can thus range from a few seconds to less than a minute, depending on dumping or restoring speed and amount of data.

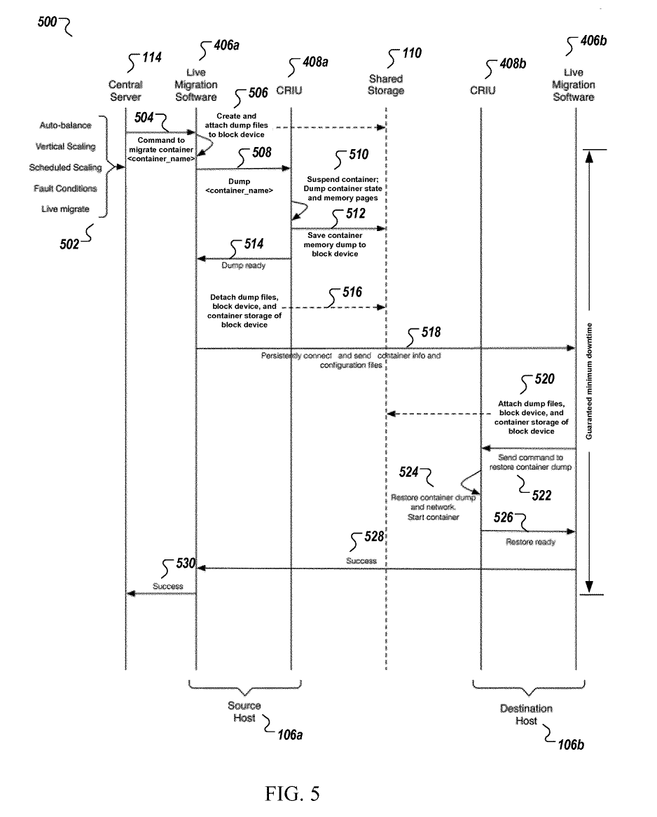

Turning now to FIG. 5, a swim lane diagram 500 illustrating container live-migration is presented, according to an illustrative embodiment of the invention.

In some example embodiments, the central server 114 initiates a task of performing a live migration of a container. The task maybe in response to the central server 114 determining an auto-balance condition, determining and/or receiving a vertical scaling condition or request, determining and/or receiving a scheduled scaling condition or request, determining and/or receiving a fault condition, or determining and/or receiving a live migration condition or request (step 502). The central server 114 may connect, via SSH or other secured message passing interface (MPI), to a container migration module 406 (shown as “Live Migration Software 406a”) that is operating on the transferring host node (shown as the “source host 106a”). The server 114 may send a command to the container migration module 406 to initiate the migration of the container 112a to a receiving host node 106b (shown as “Destination Host 106b”). In some implementations, the command includes the name or identifier of the transferring container instance 112a and the receiving host node 106 (step 504).

In some implementations, during the container migration, two block devices of the distributed file system (e.g., OCFS2, GFS, GFS2, GlusterFS clustered file system) are attached to the source host. The first device (e.g., the temporary block device) is used to store the memory dump file from the container's memory and the second device is used to store the content of the container's storage. Once the CRIU reports that the memory dump of the source host 106a is ready, the two block devices are detached from the source host 106a and then attached to the destination host 106b.

Specifically, in response to the command, the container migration module 406a (e.g., the Live Migration Software 406a) may send a command and/or request to the distributed storage devices 110 (shown as “Shared Storage 110”) to create storage blocks and to attach the created blocks to the transferring host node 106a (step 506). The commands and/or request may include a memory size value of the transferring container instance 112a that was determined prior to the container 112a being suspended. The created blocks may include a temporary block device for the memory dump file and a block device for the container's storage. The distributed storage devices 110 may create a temporary storage block of sufficient size (e.g., the same or greater than the memory size of the transferring container instance 112a) to fit the memory content (e.g., page files) of the container 112a. When the storage block is attached, the container migration module 406a may instruct the CRIU tool 408a to create a checkpoint dump 410a (as shown in FIG. 4) of the memory state of the container 112a to the temporary block device (step 508). An example command to the CRIU tool 408a is provided in Table 2.

TABLE 2
Example command to CRIU tool

Dump:

criu dump -v4 \

--file-locks \
--tcp-established \
-n net -n mnt -n ipc -n pid -n usr \
-L /usr/local/containers/lib/ \
-W /usr/local/containers/tmp/$name \
-D /usr/local/containers/tmp/$name \
-o “/usr/local/containers/tmp/$name/dump.log” \
-t “$pid” || return 1

Following params are customizable:
-v4 - verbosity
-o (-L/-W/-D) paths

In some implementations, rather than a shared storage device, the content of the memory from host node 106a may be directly transmitted into the memory of host node 106b (e.g., to increase the transfer speed and decrease the expected downtime).

To guarantee the minimum downtime during the migration, the container migration module 406a may instruct the CRIU tool 408a to create incremental backups of the content of the memory of the transferring container instance 112a (step 510). The CRIU tool 408a continues to perform such incremental backup until the difference in sizes between the last and penultimate backup is less than a predefined memory size (e.g., in x MBytes).

Once this pre-defined difference is reached, the container migration module 406 instructs the CRIU tool 408a to suspend all processes of the container 112a and dumps only the differences that remain to the physical storage device (step 512).

In response to the memory page-file dump being completed (e.g., signified by a dump complete message) by the CRIU 408a (step 514), the container migration module 406a may instruct the distributed storage devices 110 to detach the dump files 410a (e.g., temporary block device) and block device from the transferring host node 106a (step 516).

In turn, the container migration module 406a connects to second container migration module 406b operating on the destination host node 106b and transmits information about the container 112a (e.g., the container name) (step 518). The connection between the migration modules 406a and 406b may be preserved until the migration process is completed (e.g., a signal of a success or failure is received). The transmitted information may include the container name. Using the name, the second container migration module 406b may determine the remaining information to complete the migration task.

The container migration module 406a may also transfer the LxC configuration files of the container instance 112a to the destination host 106b (e.g., to the container migration module 406b). The LxC configuration files may include network settings (e.g., IP address, gateway info, MAC address, etc.) and mounting point information for the container.

An example of the transferred LxC configuration file is provided in Table 3.

TABLE 3
Example LxC Configuration File

lxc.start.auto = 1
lxc.tty = 0
lxc.console = none
lxc.pts = 10
lxc.kmsg = 0
lxc.mount.auto = proc:rw
lxc.pivotdir = putold
## Network config
lxc.autodev = 0
lxc.utsname = c411.sgvps.net
lxc.rootfs = /var/lxc/c411
lxc.network.type = veth
lxc.network.flags = up
lxc.network.name = eth0
lxc.network.ipv4 = 181.224.134.70/24
lxc.network.ipv4.gateway = 181.224.134.1
lxc.network.hwaddr = 00:16:3e:ac:5f:2f
lxc.netwo

Still with reference to FIG. 5, following receipt of the configuration file, the second container migration module 406b may instruct the distributed storage device 110 to attach the temporary block device (storing the memory dump 410a of the container 112a) and the block device of the container's storage to the destination host node 106b (step 520). An example of the commands to detach and reattach the temporary block device is provided in Table 4. “Attach/Detach” refers to a command line application that is responsible for communications with the distributed block storage drivers 110, and which performs the detaching and attaching functions. In some implementations, the first container migration module 406a provides the instructions to the distributed storage device 110.

TABLE 4
Example commands to Detach and Reattach Block Devices

Commands:
1. umount /path/to/dumpfiles/;
2. detach dump_volume (that was mounted on /path/to/dumpfiles);
3. Connect to destination host node
4. attach dump_volume
5. mount /dev/pools/dump_volume /path/to/dumpfiles

In some example implementations, steps 4 and 5 of Table 4 are executed on the destination host node.

Still with reference to FIG. 5, following the attachment of the storage blocks (e.g., the temporary block device and the container's storage) to the destination host 106b, the second container migration module 406b sends a command to the CRIU tool 408b of the destination host 106b to restore the container dump (step 522). The CRIU tool 408b restores the memory dump and network connectivity (in step 524). Once the restoration is completed, a notification is generated (step 526). Upon receipt of the notification, the CRIU tool 408b may resume the processes of the transferred container at the destination host 106b. All processes of the container are resumed from the point of their suspension. The container's network configuration is also restored on the new host node using the previously transferred configuration files of the container. Example commands to restore the memory dump at the destination host 106b is provided in Table 5.

TABLE 5
Example CRIU commands to restore
the migrated container instance

RESTORE:
LD_LIBRARY_PATH=/usr/local/containers/lib nohup setsid criu restore
-v4 \

--file-locks \
--tcp-established \
-n net -n mnt -n ipc -n pid -n usr \
--root “/var/lxc/$name” \
--veth-pair “eth0=veth$name” \
--pidfile=“/usr/local/containers/tmp/$name/pidf” \
-D “/usr/local/containers/tmp/$name” \
-o “/usr/local/containers/tmp/$name/restore.log” \
--action-script=“/usr/local/containers/lib/action-script.sh ‘$name’

‘/usr/local/containers/tmp/$name/pidf’” \

--exec-cmd -- /usr/local/containers/sbin/container-pick --name
“$name” --pidfile

“/usr/local/containers/tmp/$name/pidf” < /dev/null > /dev/null 2>&1 &

The second container migration module 406b notifies the first container migration module 406a of the transferring host node 106a that the migration is completed (step 528). The transferring host node 106a, in turn, notifies the central server 114 that the migration is completed (step 530).

In case of a failure of the migration of the container instance 112a, the container migration module 406a may resume (e.g., un-suspend) the container instance 112a on the source host 106a and reinitiate the hosted services there. A migration failure may include, for example, a failure to dump the container instance 112a by the source host 106a.

In certain failure scenarios, the container instance 112b may reinitiate the process at the new host node 106b. For example, a failure by the CRIU tool 408b to restore the dump files on the destination host 106b may result in the container migration module 406b reinitiating the restoration process at the destination node 106b.

Automatic Scaling In another aspect of the present disclosure, an exemplary automatic live resource scaling operation is now described. The scaling operation allows the automatic adding and removing of computing capability (e.g., hardware resources) of container instances running on a given host-computing device. The scaling operation allows for improved customer account density for a given set of computing resources in that a smaller number of physical computing resources are necessary to provide the equivalent level of functionality and performance for the same or higher number of customers.

In some implementations, automatic scaling is based on user-defined policies. The policies are maintained for each user account and may include policies for on-demand vertical- and horizontal-scaling and scheduled vertical- and horizontal-scaling. Vertical scaling varies (scaling up or down) the allotted computing resource of container on a given host node while horizontal scaling varies the allotted computing resource by adding or removing container instances among the host nodes.

### Automatic Vertical Scaling

In some implementations, the automatic live resource vertical scaling operation allows for the automatic adding (referred to as “scaling up”) and removing (referred to as “scaling down”) of computing capability (e.g., physical computing resources) for a given container instance. The host node can execute scaling up operations without any downtime on the target container whereby the container provides continuous hosting of services during such scaling operations. The host node can execute the scaling down operation with a minimum guaranteed interruption in some occasions (e.g. RAM scale down.)

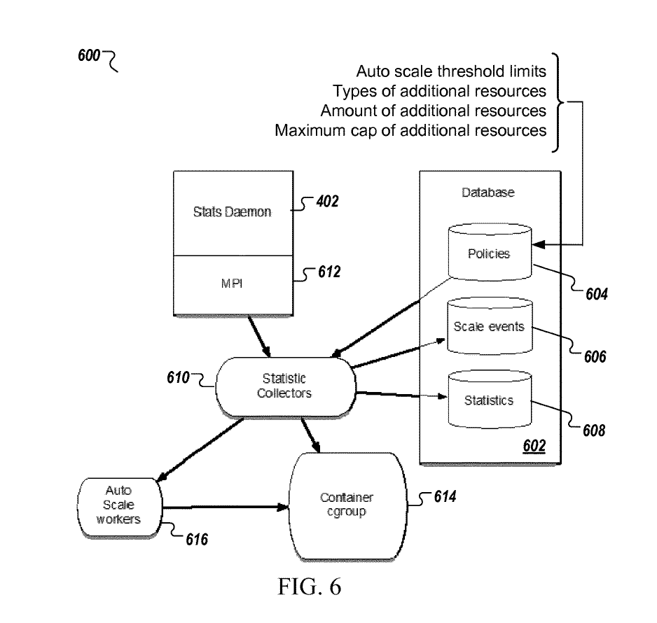

Turning now to FIG. 6, a block diagram 600 illustrating an example system for automatic scaling of host node resources is presented, according to an illustrative embodiment of the invention. Each container instance 112 interfaces with a local database 602 located on the host node 106 on which the container 112 resides. The database 602 may be configured to store data structure (e.g., keys, hashes, strings, files, etc.) to provide quick access to the data within the application execution flow. The local database 602 may store (i) a set of policies for (a) user-defined scaling configurations 604 and (b) user-defined scaling events 606, and/or (ii) usage statistics of the host-node and containers 608. The user-defined scaling policies 604 may include a threshold limit to initiate the auto scale action; a type and amount of resources to add during the action; and an overall limit of resources to add during the action.

Each of the host nodes 106 may include a MPI (message passing interface) worker 610 (shown as “statistic collectors 610”) to relay actions and requests associated with the scaling events. The MPI worker 610 may receive and serve jobs associated with the scaling event.

In some implementations, the MPI worker 610 receives the user-defined policies and scaling events as API-calls from the user 102 to which it may direct the data to be stored in the database 602 on a given host node. The MPI worker 610 may monitor these policies to initiate a scaling task. In addition, the MPI worker 610 may direct a copy of the user-defined data to the distributed storage device 110 to be stored there for redundancy. In some implementations, the MPI worker 610 receives a copy of the user-defined data associated with a given container 112 (to direct to the database 602). The MPI worker 610 may respond to such requests as part of an action to migrate to a container within the host node of the MPI worker 610.

In some implementations, the MPI worker 610 monitors the usage resources of each container 112 on the host node 106 and the total resource usage (or availability) of the host node 106, and maintains such data at the database 602. The MPI worker 610 may interface with the node resource monitor 402 (shown as “Stats Daemon 402”) to acquire such information. In turn, the node resource monitor 402 may operate in conjunction with control group (“cgroup”) 614 for each respective container 112 of the host node and directs the resource usage statistics from the container cgroup 614 to the database 602.

The MPI worker 610 may enforce the user-defined auto-scale policies 604. In some implementations, when the MPI worker 610 detects that the average resource usage (over a moving window) exceeds the threshold limit for the respective type of resource, the MPI worker 610 initiates a task and sends the task to an autoscale worker 616. The MPI worker 610 may also register the auto scale up event to the database 602 along with the container resource scaling limits.

The MPI worker 610 may also initiate the scale down events. The MPI worker 610 may initiate a scale down task for a given container if the container has been previously scaled up. In some implementations, the scale-down event occurs when the MPI worker 610 detects a free resource unit (e.g., a CPU core or a set unit of memory, e.g., 1 GByte of RAM) plus a user-defined threshold limit in the auto-scale policy. The autoscale worker 616 may execute the scale down task by updating the cgroup resource limits of the respective container instance. The scale down task is completed once the container resource is adjusted to a default value (maintained in the database 602) prior to any scale up event for that container.

When performing the scaling task, the autoscale worker 616 may update the cgroup values for the respective container 112 in real-time. The update may include redefining the new resource requirement within in the kernel. To this end, the resource is increased without an interruption to the hosting service being provided by the container. Example commands to update the control group (cgroup) is provided in Table 6.

TABLE 6
Example cgroup update commands

CPU:
echo 60000 > /cgroup/lxc/CONTAINER_NAME/cpu.cfs_period_us
echo NUMBER_OF_CPUS*60000
>/cgroup/lxc/CONTAINER_NAME/cpu.cfs_quota_us
Memory:
echo AMOUNT_IN_BYTES >
/cgroup/lxc/CONTAINER_NAME/memory.limit_in_bytes
echo AMOUNT_IN_BYTES+ALLOWED_SWAP_BYTES >
/cgroup/lxc/CONTAINER_NAME/memory.memsw.limit_in_bytes
Number of simultaneous processes running inside the container:
echo NUMBER > /cgroup/lxc/CONTAINER_NAME/cpuacct.task_limit
I/O:
echo PERCENT* 10 > /cgroup/lxc/CONTAINER_NAME/blkio.weight

In another aspect of the present disclosure, the automatic scaling operation may operate in conjunction with the container live migration operation described above. Though these operations may be performed independent of one another, in certain scenarios, one operation may trigger the other. For example, since each host node has a pre-defined limit for the node, a scaling event that causes the host node limit to be exceeded can trigger a migration event.

Turning to FIGS. 7B and 7C, graphical user interfaces for configuring on-demand auto-scaling in a hosting service account are presented, according to an illustrative embodiment of the invention. FIG. 7B illustrates an example scheduled scaling that comprises the user-defined scaling events 606, and FIG. 7C illustrates an example on-demand scaling that comprises the user-defined scaling policy 604. As shown in FIG. 7B, the user interface allows the user 102 to specify a date 716 and time 718 (e.g., in hours) for the scaling event as well as the scaling limit 720. In addition to a schedule scale up, in some implementations, the user interface can also receive a user-defined scheduled scale down of the container resources.

In some implementations, the scaling limit 720 includes additional memory 720a (e.g., in memory size, e.g., GBytes), additional processing 720b (e.g., in CPU cores), additional disk storage (e.g., in disk size, e.g., GBytes), and additional network throughput 720d (e.g., in TBytes per month). Such service can thus provide the user 102 with the ability to change the resource limits of a container linked to the user's account in anticipation of a high demand time period (e.g., a new service or product launch).

In some implementations, upon the user 102 making a change to the user account, the change is transmitted to the central server 114. The central server 114 may evaluate the user's input and the user's container to determine that the container has sufficient capacity for the user's selection.

If the central server 114 determines that the host node has sufficient resources, the user-defined scaling event is transmitted to the database 602 of the host node. The scaling event is monitored locally at the host node.

If the central server 114 determines that the host node does not have sufficient resources for the scaling event, the central server 114 may initiate a migration task, as described in relation to FIG. 4. In some implementations, the central server 114 transmits a command to the host node to migrate the container that is allocated the most resources on that node to another host node. In scenarios in which the scaling container utilizes the most resources, the central server 114 may command the next container on the list (e.g., the second most allocated container on the node) to be migrated.

FIG. 7C is a graphical user interface for configuring scheduled scaling in a hosting service account, according to an illustrative embodiment of the invention. As shown, the user interface allows the user 102 to specify a threshold limit for each allotted resource to initiate a scale up action (722), an increment amount of resource to add when the threshold is reached (724), a maximum limit for the amount of resource to add (726), and an input to enable the scale up action (728). The threshold limit 722 may be shown in percentages (e.g., 30%, 50%, 70%, and 90%). The increment amount 724 may be in respective resource units (e.g., memory block size in GBytes for RAM, number of CPU cores, storage disk block size in GBytes, etc.).

FIG. 7D is a graphical user interface for viewing statistics of servers and/or containers. For example, as shown in FIG. 7D, the user interface provides options for the types of statistics (e.g., status) to view with relation to a selected server and/or container (e.g., My Clouder). In some example implementations, configurations of the server and/or container are displayed, including its address (e.g., IP address), location (e.g., country) and maximum storage, CPU, RAM and bandwidth capacity. The types of statistics include access, usage, scale, backups, extras, and power. Selecting one of the types of statistics, such as usage statistics, causes additional options to be displayed by the user interface, to select the types of usage statistics to display. Types of usage statistics include those related to CPU, RAM, network, IOPS, and disk.

In one example implementation, selection of the CPU statistics causes a graph to be displayed, illustrating the CPU usage statistics for the selected server and/or container. The CPU usage statistics (or the like), can be narrowed to a range of time (e.g., last 30 minutes) and plotted on the graph in accordance with a selected time zone (e.g., GMT +2:00 CAT, EET, IST, SAST). In some example implementations, the graph plots and/or displays the usage during the selected time range, as well as an indication of the quota (e.g., CPU quota) for the server and/or container during the selected time range. In this way, the graph illustrates the percentage of the quota usage that is being used and/or consumed at a selected time range. It should be understood that other graphical representations (e.g., bar charts, pie charts, and the like) may be used to illustrate the statistics of the server and/or container.

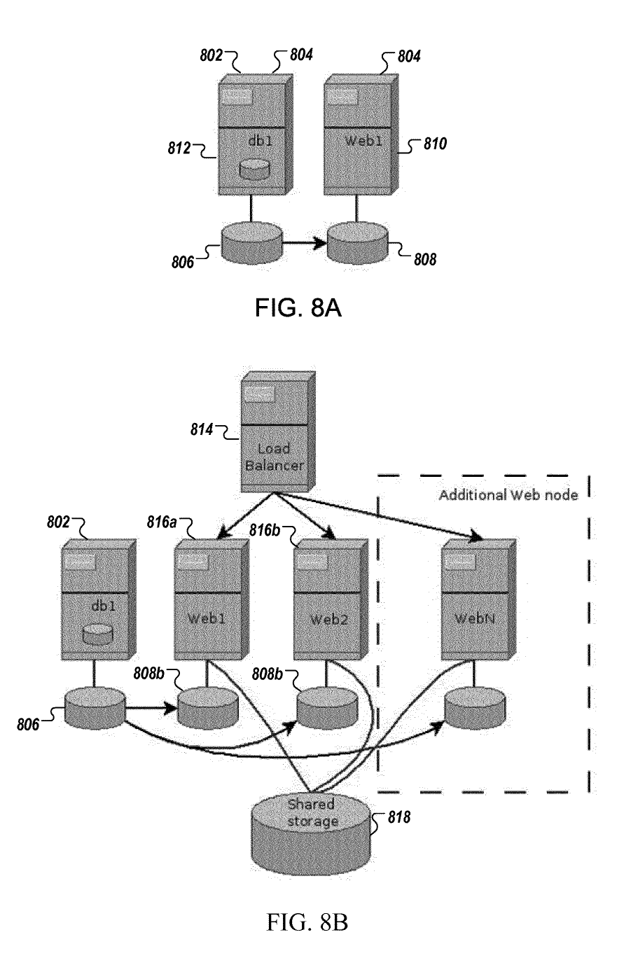

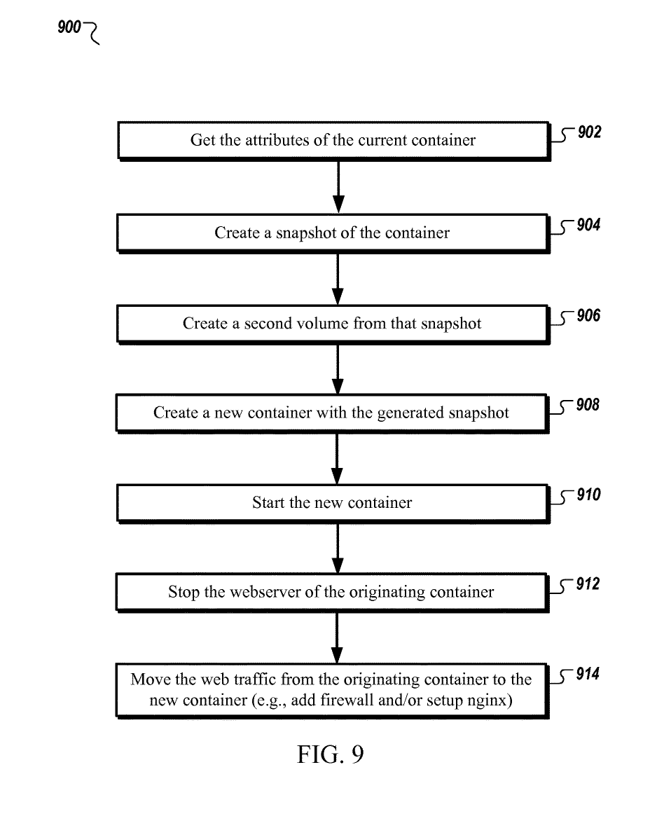

In another aspect of the present disclosure, the cloud hosting system 100 provides one or more options to the user 102 to select horizontal scaling operations. FIGS. 8A and 8B are block diagrams illustrating horizontal load-balancing options, according to an illustrative embodiment of the invention. In some implementations, the user horizontally scales from a single container 802 to a fixed number of containers 804 (e.g., 2, 3, 4, etc.), as shown in FIG. 8A. FIG. 9 is a flowchart 900 of an example method for scaling a hosted computing account, according to an illustrative embodiment of the invention.

As shown in FIG. 9, when scaling up to a fixed number of containers, the central server 114 may first inquire and receive attributes (e.g., CPU, MEM, Block device/File system sizes) of and/or from the current container instance 112 (step 902). In some implementations, the information is provided by the node resource monitor 402. Following the inquiry, the central server 114 may request the container migration module 406a (of the originating host node) to create a snapshot 806 of the container 112 (step 904). Once a snapshot is created, the central server 114 may transmit a request or command to the distributed storage device 110 to create a second volume 808 of and/or corresponding to the snapshot 806 (step 906). In turn, the central server 114 requests the container migration module 406b (of the second host node) to create a new container 810 using the generated snapshot 808 (shown as “Webl 810”) (steps 908). Once created, the new container 810 is started (step 910).

Once the new container is operating, the container migration module 406a (of the originating host node) may stop the web-services of the originating container 812 by issuing a service command inside the originating container (shown as “db1 812”) (step 912). The second container migration module 406b may then execute a script to configure the new container 810 with the network configuration of the originating container 812, thereby moving and/or redirecting the web traffic from the originating container 812 (db1) to the new container 810 (web1) (step 914).

In addition, the new container 810 may disable all startup services, except for the web server (e.g., Apache or Nginx) and SSH interface. The new container 810 may setup the file system (e.g., SSHFS, NFS or other network storage technology) on the originating container 812 (db1) so that the home folder of the client 102 is mounted to the new container 810 (web1). The new container 810 may reconfigure the web server (Apache/Nginx) to use the new IP addresses. In scenarios in which the client's application requires local access to MySQL or PgSQL, the new container 810 may employ, for example, but not limited to, a SQL-like Proxy (e.g., MySQL proxy or PGpool) to proxy the SQL traffic from the new container 810 (web1) back to the originating container 812 (db1).

Turning now to FIG. 8B, the user 102 may horizontally scale from a single container 802 to a varying number of containers. This configuration creates a new host cluster that includes a load balancing container 814 that manages the load balancing for the new cluster. In some implementations, a pre-defined number of host nodes and/or containers (e.g,. 4 and upward) is first created. The number of host nodes and containers can then be increased and/or decreased according to settings provided by the client 102 via a user interface. These computational resources are notified to the load balancer 814 to allow the load balancer to direct and manage the traffic among the sub-clusters. In some implementations, the load-balancing container 814 shares resources of its host node with another hosted container.

In some implementations, the number of host nodes and containers can be increased and/or decreased by the load balancer node 814 according to customer-defined criteria.

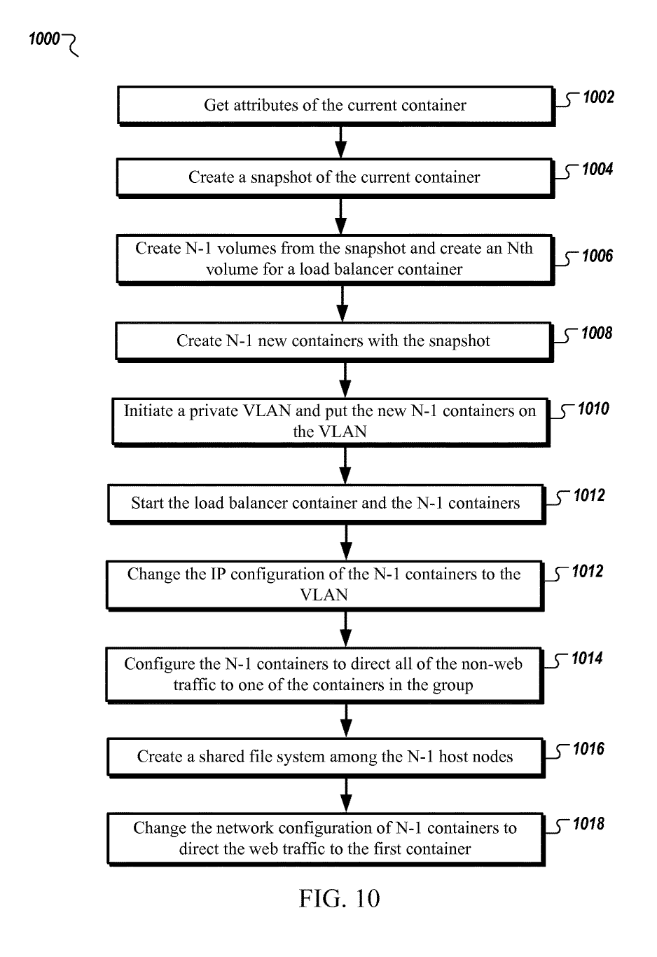

FIG. 10 is a flowchart 1000 of an example method for scaling a hosted computing account to a varying number of containers, according to an illustrative embodiment of the invention. As shown in FIG. 10, when creating the new host cluster, the central server 114 inquires and receives the attributes (e.g., CPU, MEM, Block device/File system sizes) of the current container instance 112 (step 1002). Following the inquiry, the central server 114 creates a snapshot 806 of the container 112 (step 1004). Once a snapshot is created, the central server 114 transmits a request or command to the distributed storage device 110 to create N-1 set of volumes 808b of the snapshot 806 (step 1006), where N is the total number of volume being created by the action. The central server 114 may also transmit a request to the distributed storage device 110 to create a volume (volume N) having the load balancer image (also in step 1006) and to create the load balancer container 814.

Once the N-1 set of volumes are ready (e.g., created), the central server 114 directs N-1 host nodes to create the N-1 containers in which the N-1 containers are configured with identical (or substantially identical) processing, memory, and file system configurations as the originating container 802 (step 1008). This operation may be similar to the storage block being attached and a container being initialized, as described above in relation to FIG. 4.

Subsequently, the central server 114 initiates a private VLAN and configures the containers (814, 816a, and 816b) with network configurations directed to the VLAN (step 1010). Subsequently, the central server 114 directs the load balancer container 814 to start followed by the new containers (816a and 816b) (step 1012).

Once the containers are started, the central server 114 directs the originating container 802 to move its IP address to the load balancer 814. In some implementations, the originating container 802 is directed to assign its IP address to the loopback interface on the container 802 with a net mask “/32”. This allows any IP dependent applications and/or systems that were interfacing with the originating host node 802 to preserve their network configurations.

The central server 114, in turn, configures the load balancer container 814 to forward all non-web ports to the originating container 814 (step 1014). This has the effect of directing all non-web related traffic to the originating container 814, which manages those connections. To this end, the central server 114 may direct the load balancer 814 to forward all non-web ports to the originating host node 802—which continues to manage such applications.

The central server 114 directs the N-1 host nodes to create a shared file system (step 1016). In some implementations, to create the shared file system, the central server 114 directs the distributed storage device 110 to create a new volume 818, which is equal to or larger than the snapshot 806. The central server 114 creates a shared file-system over the shared block storage using OCFS2, GFS, GFS2, or other shared files systems. The central server 114 directs the originating host node 802 to make a copy of its database (local storage) on the shared storage 818 (e.g., OCFS2, GFS, GFS2, GlusterFS clustered file system and other file system of similar capabilities) (step 1016). The central server 114 then creates a symlink (or other like feature) to maintain the web-server operation from the same node location. The central server 114 then directs the new N-1 nodes (816a and 816b) to partially start, so that the services of the shared storage 818 and the web server (e.g., Apache or Nginx) are started. The central server 114 then configures the newly created containers 816a and 816b to start their services of the shared storage 818 and the web servers (e.g., Apache or Nginx). Example code to initiate the OCFS2 service (e.g., of the shared storage 818) is provided in Table 7.

TABLE 7
Example code to initiate shared storage

bash script:
for i in $(chkconfig --list|awk ‘/3:on/ && $1 !~
/network|o2cb|ocfs2|sshd/{print $1}’); do
chkconfig $i off; done

Once the shared file system is setup, the central server 114 configures the network configuration of the web-server applications for all the containers in the cluster by a self-identification method of the web services running on the containers (step 1018). This self-identification of the web server allows new containers to be provisioned and configured without the client 102 having to provide information about the identity and type of their web-server applications. This feature allows the hosted services to be scaled quickly and seamlessly to the user 102 in the cloud environment.

To identify the configuration of the web servers (e.g., as Apache, Varnish, Lighttpd, LiteSpeed, and Squid, among others) and change the IP configuration of the web servers, the central server 114 identifies the process identifier(s) (PIDs) of the one or more services that are listening on web-based ports (e.g., ports 80 and 443). The central server 114 then identifies the current working directory and the executable of the applications, for example, using command line operations to retrieve PID(s) of the container. An example command line operation is provided in Table 8.

TABLE 8
Example command to identify process
identifiers of container services

Cmdline:
: /proc/PID/cwd and /proc/PID/exe.

The central server 114 may test for the application type by sending different command line options to the application and parsing the resulting output. Based on the identified application, a default configuration is identified by matching, for example, keywords, character strings, format of the outputted message, or whether the application provides a response to the command line. The central server 114 then checks the configurations files of the container for the IP configuration (e.g., the IP addresses) of the web servers and replaces them.

In scenarios in which an application requires local access to MySQL or PgSQL, a SQL Proxy is employed (for example, but not limited to, MySQL proxy or PGpool) on a new container 816a, which proxies the SQL traffic back to the originating container 802.

The central server 114 may configure the web traffic as a reverse proxy using, for example, Nginx or HAproxy, or other load balancing scheme. The new container 816a and 816b, the network information (e.g., IP address) that are seen by the application on the web servicing containers are replaced with, for example, but not limited to, Apache's mod_rpaf.

In some implementations, when the number of host nodes in the cluster reaches more than a predetermined number (e.g., six), the central server 114 may provide a notification to the client 102 to add more database nodes.

### Pre-Provisioning of Containers and Standby Storage Block Devices

In another aspect of the present disclosure, the cloud hosting system 100 is configured to pre-provision container instances with different container configuration and Linux distribution. In other words, undesignated containers may be initialized and placed in standby mode and ready to be used. The pre-provisioning allows new containers to appear to be provisioned in the shortest possible interval.

In some implementations, stand-by storage block devices of the distributed storage devices 110 may be loaded with ready-to-use pre-installed copies of Linux or Unix distributions. When a request to create new containers is received (e.g., from the user or internally to scale a given user account), the central server 114 can instruct the storage block devices to become attached to a designated host node. The container may be initialized and the configuration renamed according to the request. The stand-by operation takes much less time compared to the copying of the entire data set when a new container instance 112 is needed.

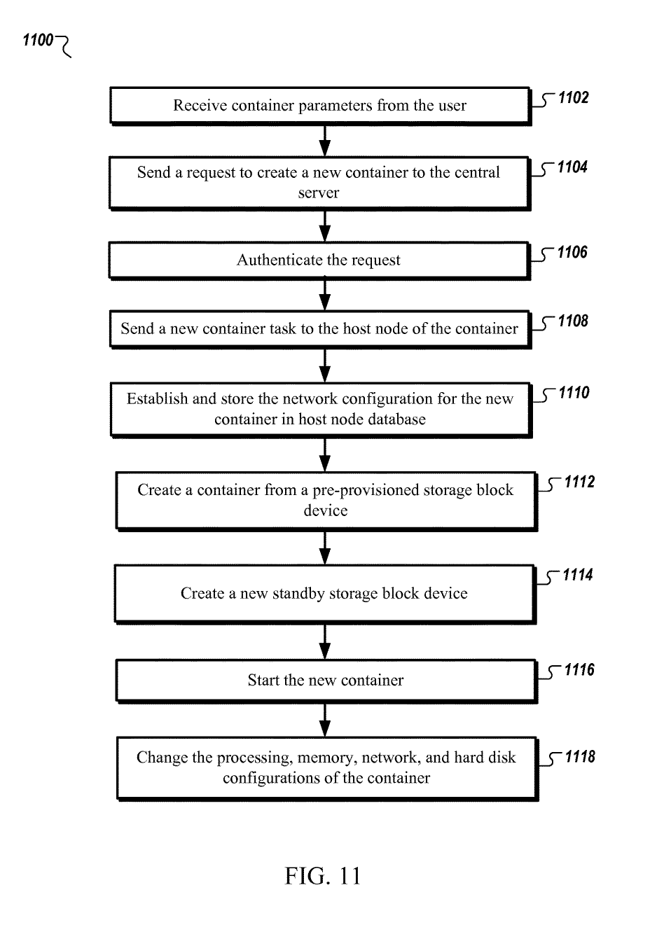

Turning now to FIG. 11, a flowchart 1100 of an example method to pre-provision a host-computing device is presented, according to an illustrative embodiment of the invention.

The user interface 700 receives parameters from the user 102, as for example described in relation to FIG. 7A. The parameters may include a type of Linux distribution for the container; a configuration for the Linux distribution with the various pre-installed applications (e.g., web server, databases, programming languages); custom storage capacity for the container; number of CPU cores for the container; amount of memory for the container; available bandwidth for the container; and a password to access the container (e.g., over SSH).

The interface 700 provides the request, via an API call, to the central server 114 (step 1104). The central server 114 verifies the request and determines its suitability. The verification may be based on a check of the user's account as well as the authentication token accompanying the request. The suitability may be based on the availability of resources among the host nodes. Upon a determination of a suitable host node, a task ID is generated and assigned to the request. The central server 114 forwards the task, via asynchronous connection (in some implementations), to the destination host node 106 (e.g. to a job manager) (step 1108). The host node 106 returns a response to the central server 114 with the task ID.

The job manager establishes a new network and tracking configuration for the container 112 and stores the configuration in the database 602 of the host node 106 (1110). A container is created from pre-provisioned storage block devices (1112). The pre-provisioning allows for minimum delay from the storage device when provisioning a new container. A new storage block device is provisioned with the same Linux or Unix configuration and/or image as a new pre-provisioned storage block device (step 1114). The pre-provisioned task may be performed as a background operation. If a stand-by, pre-provisioned storage device is not available, a copy of a cold-spare storage device is provisioned.

The job manager initiates the new container (step 1116) and (i) directs the kernel (e.g., via cgroup) to adjust the processing, memory, and network configuration after the container has been initiated and (ii) directs the distributed storage device 110 to adjust the hard disk configuration (step 1118). The job manager sends a callback to the central server 114 to notify that the provisioning of the new container is completed.

In some implementations, the pre-provisioning may be customized to provide user 102 with flexibility (e.g., selecting memory and/or CPU resources, disk size, and network throughput, as well as Linux distribution) in managing their hosted web-services. To this end, when a new container is needed, the existing pre-provisioned containers are merely modified to have parameters according to or included in the request.

In some implementations, a job management server pre-provisions the standby container and/or standby storage block devices. The job management server may queue, broker, and manage tasks that are performed by job workers.

In some implementations, the cloud computing system 100 maintains an updated library of the various Linux operating system and application distributions. Turning back to FIG. 1, the system 100 may include a library server 116. The library server may maintain one or more copies to the various images utilized by the containers. For example, the library server may maintain one or more copies of all installed packages; one or more copies of all Linux distributions; one or more copies of installed images of the pre-provisioned storage devices; one or more copies of images of the cold-spare storage devices; and one or more copies of up-to-date available packages for the various Linux distributions, web server applications, and database applications.

The library server 116 may direct or operate in conjunction with various worker classes to update the deployed Linux distribution and distributed applications with the latest patch and/or images. The server 116 may automatically detect all hot-spare and cold-spare storage devices to determine if updates are needed—thus, no manual intervention is needed to update the system. In some implementations, the updated task may be performed by Cron daemon and Cron job. The system 100 may include functions to update the Linux namespace with certain parameters to ensure that the updates are executed in the proper context. To this end, the user 102 does not have to interact with the container to update distributions, applications, or patches.

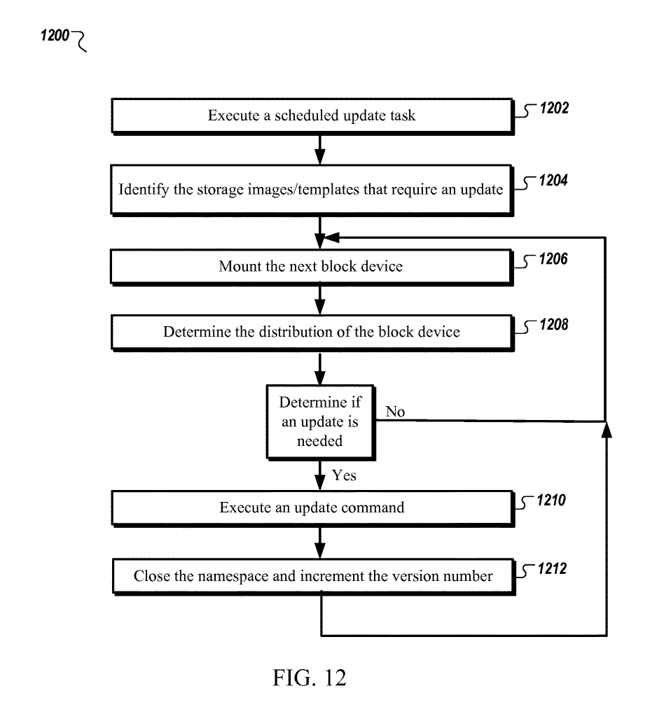

FIG. 12 is a flowchart 1200 of an example method for automatic update of the deployed containers, according to an embodiment of the invention. One or more servers handle the hot and cold spare storage images/templates updates.

In some implementations, Cron job executes a scheduled update task (step 1202). The task may be manually initiated or may be automatically generated by a scheduling server (e.g., the central server 114) in the system 100. The Cron job may automatically identify the storage images/templates that require an update (step 1204). In some implementations, the identification may be based on the naming schemes selected to manage the infrastructure. For example, hot and cold spare images and/or templates differ significantly in name usages to the storage devices that host the data for the provisioned containers. Using rules based on name usages, the system automatically identifies versions of such images and/or templates, thereby determining if a newer image is available.

For each block device, the distributed storage device mounts the block device (step 1206) to determine the distribution version using the Linux Name Space (step 1208). If an update is needed (e.g., based on the naming schemes), the Cron job initiates and executes an update command (step 1210). The Linux Name Space is then closed and the version number is incremented (step 1212).

### Health Monitoring and Failover Operation

Referring to FIG. 4, in addition to efficiency, the node resource monitor 402 (e.g., the stat daemon 402) provides vital monitoring to ensure reliable operation of the host computing nodes 106. When a given host node becomes inoperable, all containers 112 hosted on that host node also becomes inoperable. To this end, in addition to monitoring, the node resource monitor 402 may provide reporting of conditions of its host node. The reporting may be employed to trigger notifications, trigger live-migrate actions, and provide tracking of the host nodes for anomalous behaviors.

The node resource monitor 402 may operate with a central monitoring system that provides monitoring and reporting for the host node conditions. This action allow for high availability and fault tolerance for all containers running on a given host node. Depending on detected abnormal events, different actions may be taken, such as to trigger an event notification or to migrate the containers and internal data structures to anther host node. When an anomalous condition is detected, the central monitoring system may flag the host node exhibiting the condition to prevent any containers from being initiated there as well as to prevent any migration of containers to that node. The node resource monitor 402 may provide the current resource usage (e.g., of the processing, memory, network throughput, disk space usage, input/output usage, among others) to be presented to the user 102 by the host node. An example reporting via the user interface is provided in FIG. 7D. The node resource monitor 402 may store the usage information on the local database 602, which may be accessed by the host node to present the usage history information to the user.

Referring still to FIG. 4, when migrating containers, the computing resources and health of the destination host nodes are taken into account. The migration may be performed across several host nodes to reduce the likelihood of a cascading overload. The central monitoring system may receive a list of all nodes. Each node in the list may include node-specific information, such as cluster membership, network configuration, cluster placement, total used and free resources of the node (e.g., cpu, memory, hdd), and a flag indicating whether the node is suitable for host migration events.

The central monitoring system may operate with a local monitoring system, which monitors and reports the status of system on each host node. The central monitoring system maintains a list of flagged host nodes. The central monitoring system performs a separate check for each node in each cluster. The central monitoring system checks network connectivity with the local monitoring system to assess for anomalous behavior.

When an abnormal status is returned by the local monitoring system to the central monitoring system, the host node on which the local monitoring system resides is flagged. When the flag is changed, the central monitoring system performs additional actions to assess the health of that host node. An additional action may include, for example, generating an inquiry to the neighboring host nodes within the same cluster for the neighbor's assessment of the flagged host node. The assessment may be based, for example, on the responsiveness of the host node to an inquiry or request (previously generated or impromptu request) by the neighboring host node.

The central monitoring system may maintain a counter of the number of flagged host nodes within the cluster. When migrating containers, if the number of such flagged nodes exceed a given threshold, no actions are taken (to prevent the cascading of the issues), else the containers on such nodes are migrated to another host node.

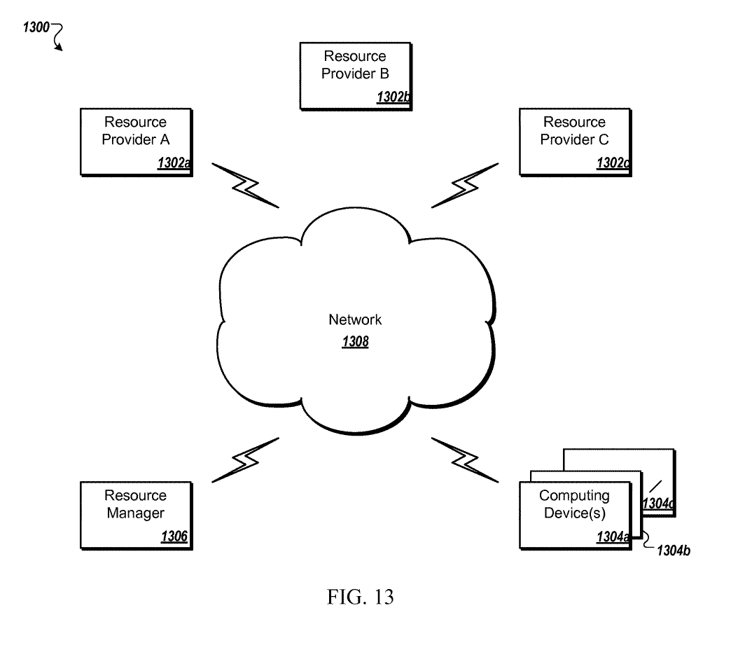

As shown in FIG. 13, an implementation of an exemplary cloud-computing environment 1300 for development of cross-platform software applications is shown and described. The cloud-computing environment 1300 includes one or more resource providers 1302a, 1302b, 1302c (collectively, 1302). Each resource provider 1302 includes computing resources. In some implementations, computing resources include any hardware and/or software used to process data. For example, computing resources may include hardware and/or software capable of executing algorithms, computer programs, and/or computer applications. In some implementations, exemplary computing resources include application servers and/or databases with storage and retrieval capabilities. Each resource provider 1302 is connected to any other resource provider 1302 in the cloud-computing environment 1300. In some implementations, the resource providers 1302 are connected over a computer network 1308. Each resource provider 1302 is connected to one or more computing device 1304a, 1304b, 1304c (collectively, 1304), over the computer network 1308.

The cloud-computing environment 1300 includes a resource manager 1306. The resource manager 1306 is connected to the resource providers 1302 and the computing devices 1304 over the computer network 1308. In some implementations, the resource manager 1306 facilitates the provisioning of computing resources by one or more resource providers 1302 to one or more computing devices 1304. The resource manager 1306 may receive a request for a computing resource from a particular computing device 1304. The resource manager 1306 may identify one or more resource providers 1302 capable of providing the computing resource requested by the computing device 1304. The resource manager 1306 may select a resource provider 1302 to provide the computing resource. The resource manager 1306 may facilitate a connection between the resource provider 1302 and a particular computing device 1304. In some implementations, the resource manager 1306 establishes a connection between a particular resource provider 1302 and a particular computing device 1304. In some implementations, the resource manager 1306 redirects a particular computing device 1304 to a particular resource provider 1302 with the requested computing resource.

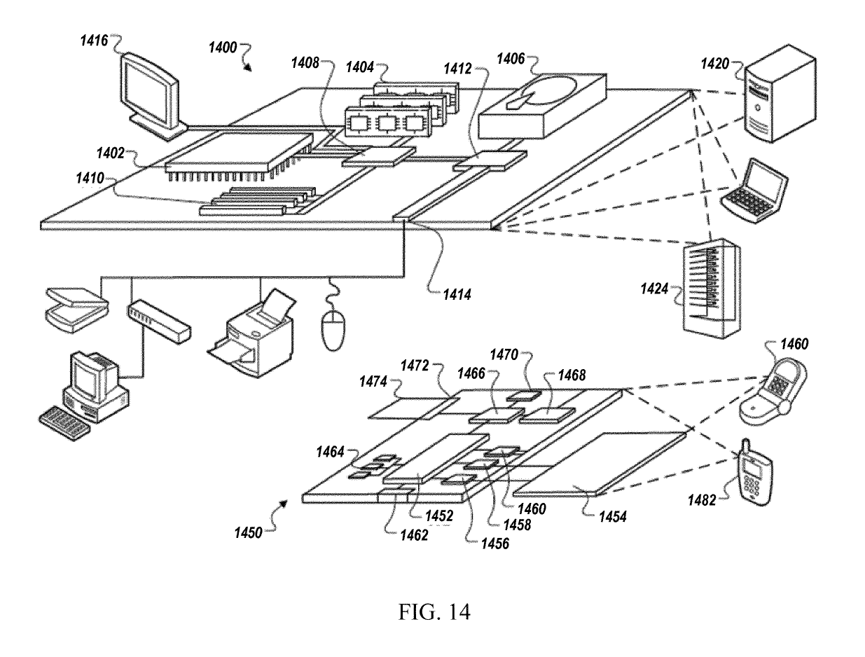

FIG. 14 shows an example of a computing device 1400 and a mobile computing device 1450 that can be used to implement the techniques described in this disclosure. The computing device 1400 is intended to represent various forms of digital computers, such as laptops, desktops, workstations, personal digital assistants, servers, blade servers, mainframes, and other appropriate computers. The mobile computing device 1450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1400 includes a processor 1402, a memory 1404, a storage device 1406, a high-speed interface 1408 connecting to the memory 1404 and multiple high-speed expansion ports 1414, and a low-speed interface 1412 connecting to a low-speed expansion port 1414 and the storage device 1406. Each of the processor 1402, the memory 1404, the storage device 1406, the high-speed interface 1408, the high-speed expansion ports 1414, and the low-speed interface 1412, are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as a display 1416 coupled to the high-speed interface 1408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 may also be another form of computer-readable medium, such as a magnetic or optical disk.

The storage device 1406 is capable of providing mass storage for the computing device 1400. In some implementations, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1402), perform one or more methods, such as those described above. The instructions can also be stored by one or more storage devices such as computer- or machine-readable mediums (for example, the memory 1404, the storage device 1406, or memory on the processor 1402).

The high-speed interface 1408 manages bandwidth-intensive operations for the computing device 1400, while the low-speed interface 1412 manages lower bandwidth-intensive operations. Such allocation of functions is an example only. In some implementations, the high-speed interface 1408 is coupled to the memory 1404, the display 1416 (e.g., through a graphics processor or accelerator), and to the high-speed expansion ports 1414, which may accept various expansion cards (not shown). In the implementation, the low-speed interface 1412 is coupled to the storage device 1406 and the low-speed expansion port 1414. The low-speed expansion port 1414, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1400 may be implemented in a number of different forms, as shown in the figure. For example, it may be implemented as a standard server 1420, or multiple times in a group of such servers. In addition, it may be implemented in a personal computer such as a laptop computer 1422. It may also be implemented as part of a rack server system 1424. Alternatively, components from the computing device 1400 may be combined with other components in a mobile device (not shown), such as a mobile computing device 1450. Each of such devices may contain one or more of the computing device 1400 and the mobile computing device 1450, and an entire system may be made up of multiple computing devices communicating with each other.

The mobile computing device 1450 includes a processor 1452, a memory 1464, an input/output device such as a display 1454, a communication interface 1466, and a transceiver 1468, among other components. The mobile computing device 1450 may also be provided with a storage device, such as a micro-drive or other device, to provide additional storage. Each of the processor 1452, the memory 1464, the display 1454, the communication interface 1466, and the transceiver 1468, are interconnected using various buses, and several of the components may be mounted on a common motherboard or in other manners as appropriate.

The processor 1452 can execute instructions within the mobile computing device 1450, including instructions stored in the memory 1464. The processor 1452 may be implemented as a chipset of chips that include separate and multiple analog and digital processors. The processor 1452 may provide, for example, for coordination of the other components of the mobile computing device 1450, such as control of user interfaces, applications run by the mobile computing device 1450, and wireless communication by the mobile computing device 1450.

The processor 1452 may communicate with a user through a control interface 1458 and a display interface 1456 coupled to the display 1454. The display 1454 may be, for example, a TFT (Thin-Film-Transistor Liquid Crystal Display) display or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may provide communication with the processor 1452, so as to enable near area communication of the mobile computing device 1450 with other devices. The external interface 1462 may provide, for example, for wired communication in some implementations, or for wireless communication in other implementations, and multiple interfaces may also be used.

The memory 1464 stores information within the mobile computing device 1450. The memory 1464 can be implemented as one or more of a computer-readable medium or media, a volatile memory unit or units, or a non-volatile memory unit or units. An expansion memory 1404 may also be provided and connected to the mobile computing device 1450 through an expansion interface 1412, which may include, for example, a SIMM (Single In Line Memory Module) card interface. The expansion memory 1414 may provide extra storage space for the mobile computing device 1450, or may also store applications or other information for the mobile computing device 1450. Specifically, the expansion memory 1414 may include instructions to carry out or supplement the processes described above, and may include secure information also. Thus, for example, the expansion memory 1414 may be provide as a security module for the mobile computing device 1450, and may be programmed with instructions that permit secure use of the mobile computing device 1450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. That the instructions, when executed by one or more processing devices (for example, processor 1452), perform one or more methods, such as those described above. The instructions can also be stored by one or more storage devices, such as one or more computer- or machine-readable mediums (for example, the memory 1464, the expansion memory 1414, or memory on the processor 1452). In some implementations, the instructions can be received in a propagated signal, for example, over the transceiver 1468 or the external interface 1462.

The mobile computing device 1450 may communicate wirelessly through the communication interface 1466, which may include digital signal processing circuitry where necessary. The communication interface 1466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1468 using a radio frequency. In addition, short-range communication may occur, such as using a Bluetooth®, Wi-Fi™, or other such transceiver (not shown). In addition, a GPS (Global Positioning System) receiver module 1414 may provide additional navigation- and location-related wireless data to the mobile computing device 1450, which may be used as appropriate by applications running on the mobile computing device 1450.

The mobile computing device 1450 may also communicate audibly using an audio codec 1460, which may receive spoken information from a user and convert it to usable digital information. The audio codec 1460 may likewise generate audible sound for a user, such as through a speaker, e.g., in a handset of the mobile computing device 1450. Such sound may include sound from voice telephone calls, may include recorded sound (e.g., voice messages, music files, etc.) and may also include sound generated by applications operating on the mobile computing device 1450.

The mobile computing device 1450 may be implemented in a number of different forms, as shown in the figure. For example, it may be implemented as a cellular telephone 1480. It may also be implemented as part of a smart-phone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, environments and methods for developing cross-platform software applications are provided. Having described certain implementations of methods and apparatus for supporting the development and testing of software applications for wireless computing devices, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method of load balancing of a host computing devices, the method comprising:
receiving, via a processor of a supervisory computing device (e.g., central server), one or more resource usage statistics (e.g., CPU, memory, disk storage, and network bandwidth) of one or more containers operating on a first host computing device, the first host computing device running an operating system kernel having one or more sets of isolated process groups (e.g., namespaces, which are limited with cgroups), each of the one or more sets of isolated process groups corresponding to each of the one or more containers;
determining, via the processor, whether (i) the one or more resource usage statistics of each of one or more containers linked to a given user account exceed (ii) a first set of threshold values associated with the given user account; and
responsive to the determination that at least one of the compared resource usage statistics of the one or more containers exceeds the first set of threshold values, transmitting, via the processor, a command (e.g., API function) to the first host computing device to migrate the container associated with the compared resource usage statistics from the first host computing device to a second host computing device selected from a group of host computing devices, wherein the command includes (i) an identifier of the compared container determined to be exceeding the first set of threshold values, and (ii) an identifier of the second host computing device.

2. The method of claim 1, wherein the second host computing device is selected, by the supervisory computing device, as a host computing device having a level of resources greater than that of other host computing devices among the group of host computing devices.

3. The method of claim 1, wherein the migrated container is transferred to a pre-provisioned container on the second host-computing device.

4. The method of claim 3, wherein the pre-provisioned container includes an image having one or more applications and operating system that are identical to that of the transferred container.

5. The method of claim 4, wherein the second host computing device is selected, by the supervisory computing device, as a host computing device having a pre-provisioned container running the same image as the compared container.

6. The method of claim 1, wherein the first host computing device compares, via a processor of the first host computing device, (i) an average of one or more resource usage statistics of each of the one or more containers operating on the first host computing device to (ii) a second set of threshold values (e.g., up-scaling threshold) associated with the given user account; and
responsive to at least one of the averaged resource usage exceeding the second set of threshold values for a given container, the first host computing device being configured to adjust one or more resource allocations of the given container to an elevated resource level (e.g., increased CPU, memory, disk storage, and/or network bandwidth) defined for the given user account.

7. The method claim 6 (e.g., for auto down-scaling), wherein:
subsequent to the first host computing device adjusting the one or more resource allocations of the given container to the elevated resource level, the first host computing device being configured to compare, via the processor of the first host computing device, (i) the average of one or more resource usage statistics of each container operating on the first host computing device to (ii) a third set of threshold values (e.g. down-scaling threshold) associated with the given user account; and
responsive to the averaged resource usage being determined to be below the third set of threshold values for the given container, the first host computing device being configured to adjust the one or more resource allocations of the given container to a level between the elevated resource level and an initial level defined in the given user account.

8. A method for migrating a container from a first host computing device to a second host computing device (e.g., with guaranteed minimum downtime, e.g., less than 10 seconds) while maintaining hosting of the web-services provided by the container, the method comprising:
receiving, via a processor on a first host computing device, a command to migrate a container from the first computing device to a second host computing device, the processor running an operating system kernel;
responsive to the receipt of the command, instructing, via the processor, the kernel to store a state of one or more computing processes being executed within the container in a manner that the one or more computing processes are subsequently resumed from the state (e.g., checkpoint), the state being stored as state data;
transmitting, via the processor, first instructions to a storage device to create a storage block and to attach the storage block to the first host computing device over a network, wherein the storage device is operatively linked to both the first host computing device and second host computing device via the network;
responsive to the storage block being attached to the first host computing device, instructing, via the processor, the kernel to store one or more portions of the state data to the storage block, wherein a remaining portion of the state data is at least a pre-defined data size (e.g., a few KBytes or MBytes);
instructing, via the processor, the kernel to halt all computing processes associated with the container;
instructing, via the processor, the kernel to store the remaining portion of the state data of the pre-defined data size in the storage block; and
responsive to the remaining portion of the state data being stored:
transmitting, via the processor, second instructions to the storage device to detach the storage block from the first host computing device and to attach the storage block to the second host computing device; and
transmitting, via the processor, third instructions to the second host computing device, wherein the third instructions include one or more files having network configuration information of the container of the first host computing device, wherein upon receipt of the third instructions, the second host computing device is configured to employ the received one or more configuration files to (i) establish the container at the second host computing device and (ii) to resume the state of the one or more computing processes of the container executing on the second host computing device using the attached state data.

9. The method of claim 8, wherein the one or more portions of the state data are stored in the storage block in an incremental manner.

10. The method of claim 9, wherein the one or more portions of the state data are stored to the storage block in an incremental manner until a remaining portion of the state data defined by a difference between the a last storing instance and a penultimate storing instance is less than a pre-defined data size.

11. A non-transitory computer readable medium having instructions thereon, wherein the instructions, when executed by a processor, cause the processor to:
receive one or more resource usage statistics (e.g., CPU, memory, disk storage, and network bandwidth) of one or more containers operating on a first host computing device, the first host computing device running an operating system kernel having one or more sets of isolated process groups (e.g., namespaces, which are limited with cgroups), each of the one or more sets of isolated process groups corresponding to each of the one or more containers;
determine whether (i) the one or more resource usage statistics of each of one or more containers linked to a given user account exceeds (ii) a first set of threshold values associated with the given user account; and
responsive to the determination that at least one of the compared resource usage statistics of the one or more containers exceeding the first set of threshold values, transmit a command (e.g., API function) to the first host computing device to migrate the container associated with the compared resource usage statistics from the first host computing device to a second host computing device selected from a group of host computing devices, wherein the command includes (i) an identifier of the compared container determined to be exceeding the first set of threshold values and (ii) an identifier of the second host computing device.

12. The computer readable medium of claim 11, wherein the second host computing device is selected, by the supervisory computing device, as a host computing device having a level of resources greater than that of other host computing devices among the group of host computing devices.

13. The computer readable medium of claim 11, wherein the migrated container is transferred to a pre-provisioned container on the second host-computing device.

14. The computer readable medium of claim 13, wherein the pre-provisioned container includes an image having one or more applications and operating system that are identical to that of the transferred container.

15. The computer readable medium of claim 14, wherein the second host computing device is selected as a host computing device having a pre-provisioned container running the same image as the compared container.

16. The computer readable medium of claim 11, wherein the first host computing device compares, via a processor of the first host computing device, (i) an average of one or more resource usage statistics of each of the one or more containers operating on the first host computing device to (ii) a second set of threshold values (e.g., up-scaling threshold) associated with the given user account; and
responsive to at least one of the averaged resource usage statistics exceeding the second set of threshold values for a given container, the first host computing device being configured to adjust one or more resource allocations of the given container to an elevated resource level (e.g., increased CPU, memory, disk storage, and/or network bandwidth) defined for the given user account.

17. The computer readable medium claim 16 (e.g., for auto down-scaling), wherein:
subsequent to the first host computing device adjusting the one or more resource allocations of the given container to the elevated resource level, the first host computing device being configured to compare, via the processor of the first host computing device, (i) the average of one or more resource usage statistics of each container operating on the first host computing device to (ii) a third set of threshold values (e.g. down-scaling threshold) associated with the given user account; and
responsive to the averaged resource usage being determined to be below the third set of threshold values for the given container, the first host computing device being configured to adjust the one or more resource allocations of the given container to a level between the elevated resource level and an initial level defined in the given user account.

18. A non-transitory computer readable medium having instructions thereon, wherein the instructions, when executed by a processor, cause the processor to:
receive a command to migrate a container from the first computing device to a second host computing device, the processor running an operating system kernel;
responsive to the receipt of the command, instruct the kernel to store a state of one or more computing processes being executed within the container in a manner that the one or more computing processes are subsequently resumed from the state (e.g., checkpoint), the state being stored as state data;
transmit first instructions to a storage device to create a storage block and to attach the storage block to the first host computing device over a network, wherein the storage device is operatively linked to both the first host computing device and second host computing device via the network;
responsive to the storage block being attached to the first host computing device, instruct the kernel to store one or more portions of the state data to the storage block, wherein a remaining portion of the state data is at least a pre-defined data size (e.g., a few KBytes or MBytes);
instruct the kernel to halt all computing processes associated with the container;
instruct the kernel to store the remaining portion of the state data of the pre-defined data size in the storage block; and
responsive to the remaining portion of the state data being stored:
transmit second instructions to the storage device to detach the storage block from the first host computing device and to attach the storage block to the second host computing device; and
transmit third instructions to the second host computing device, wherein the third instructions include one or more files having network configuration information of the container of the first host computing device, wherein upon receipt of the third instructions, the second host computing device is configured to employ the received one or more configuration files to (i) establish the container at the second host computing device and (ii) to resume the state of the one or more computing processes of the container executing on the second host computing device using the attached state data.

19. The computer readable medium of claim 18, wherein the one or more portions of the state data are stored in the storage block in an incremental manner.

20. The computer readable medium of claim 19, wherein the one or more portions of the state data are stored to the storage block in an incremental manner until a remaining portion of the state data defined by a difference between a last storing instance and a penultimate storing instance is less than a pre-defined data size.

21. A method for scaling resource usage of a host server, the method comprising:
receiving, via a processor of a host computing device, one or more resource usage statistics of one or more containers operating on the host computing device, the host computing device running an operating system kernel having one or more sets of isolated process groups (e.g., namespaces, which are limited with cgroups), each of the sets of isolated process groups corresponding to each of the one or more containers;
comparing, via the processor, (i) an average of the one or more resource usage statistics of each of the one or more containers to (ii) a first set of threshold values associated with each given user account that is linked to the one or more compared containers; and
responsive to at least one of the averaged resource usage statistics of the one or more containers exceeding the first set of threshold values for a given compared container from the one or more containers, adjusting one or more resource allocations of the given compared container by a level defined for the given user account.

22. The method of claim 21, wherein the adjustment of the one or more resource allocations of the given compared container comprises an update to the cgroup of the operating system kernel.

23. The method of claim 21, wherein the level comprises an increment of resource units (e.g., CPU cores for processing resources, GBytes of RAM for memory resources, GBytes for network bandwidth, and/or GBytes of hard disk for data storage).

24. The method of claim 21, wherein subsequent to the first host computing device adjusting the one or more resource allocations of the given compared container to the level, the method comprises:
comparing, via a processor of the host computing device, (i) the average of the one or more resource usage statistics of each of the one or more containers operating on the host computing device to (ii) a third set of threshold values (e.g. down-scaling threshold) associated with the given user account; and
responsive to the averaged resource usage statistics being determined to be below the third set of threshold values for the given compared container, adjusting the one or more resource allocations of the given compared container to a level between an elevated resource level and the level defined in the given user account.

25. The method of claim 21 further comprising:
comparing, via the processor, (i) an average of one or more resource usage statistics of each of the one or more containers to (ii) a second set of threshold values associated with the given user account that is associated with the given compared container; and
responsive to at least one of the averaged resource usage statistics of the one or more containers exceeding the second set of threshold values for the given compared container, migrating the given compared container to one or more containers operating on two or more host computing devices in accordance with a user-defined scaling rule (e.g., 1:2 or 1:4 or more).

26. The method of claim 25, wherein the migrating (e.g., 1:2) of the given compared container to the one or more containers operating on two or more host computing devices comprises:
retrieving, via the processor, attributes of the given compared container (e.g., CPU, memory, Block device/File system sizes);
creating, via the processor, a snapshot of the given compared container, the compared container hosting one or more web services, wherein the snapshot comprises an image of web service processes operating in the memory and kernel of the given compared container;
causing, via the processor, a new volume to be created at each new host computing device of the two or more host computing devices;
causing, via the processor, a new container to be created in each of the new volumes, wherein the new containers comprise the snapshot of the compared container;
starting one or more web service processes of the snapshot in each of the new containers;
stopping the one or more web services of the given compared container; and
transferring traffic from (i) the one or more web services of the given compared container to (ii) one or more web services of the new containers.

27. The method of claim 26 further comprising:
causing, via the processor, a firewall service to be added to the one or more web services of the new containers.

28. The method of claim 21, wherein the migration of the given compared container to the one or more containers operating on two or more host computing devices comprises:
retrieving, via the processor, attributes of the given compared container (e.g., CPU, memory, Block device/File system sizes);
creating, via the processor, a snapshot of the given compared container, the given compared container hosting one or more web services, wherein the snapshot comprises an image of processes operating in the memory and kernel of the given compared container;
causing, via the processor, a new container to be created in each of new volumes and a load balancing container to be created in a load balance volume;
causing, via the processor, each of the new containers to be linked to the load balancing container, wherein the load balancing container is configured to monitor usage statistics among the new containers and adjust resource allocation of the new containers to be within a pre-defined threshold;
stopping the one or more web services of the given compared container; and
transferring traffic from (i) the one or more web services of the given compared container to (ii) one or more web services of the new containers.

29. A system for scaling resource usage of a host server, the system comprising:
a processor;
a memory having instructions thereon, wherein the instructions, when executed by the processor, cause the processor to:
receive one or more resource usage statistics of one or more containers operating on the host computing device, the host computing device running an operating system kernel having one or more sets of isolated process groups (e.g., namespaces, which are limited with cgroups), each of the sets of isolated process groups corresponding to each of the one or more containers;
compare (i) an average of the one or more resource usage statistics of each of the one or more containers to (ii) a first set of threshold values associated with each given user account that is associated with the one or more compared containers; and
responsive to at least one of the averaged one or more resource usage statistics of the one or more containers exceeding the first set of threshold values for a given compared container from the one or more containers, adjust one or more resource allocations of the given compared container by a level defined for the given user account.

30. The system of claim 29, wherein the adjustment of the one or more resource allocations of the given compared container comprises an update to the cgroup of the operating system kernel.

31. The system of claim 29, wherein the level comprises an increment of resource units (e.g., CPU cores for processing resources, GBytes of RAM for memory resources, GBytes for network bandwidth, and/or GBytes of hard disk for data storage).

32. The system of claim 29, wherein subsequent to the first host computing device adjusting the one or more resource allocations of the given compared container to the level,
the instructions, when executed, further cause the processor to compare (i) the average of the one or more resource usage statistics of each of the one or more containers operating on the host computing device to (ii) a third set of threshold values (e.g. down-scaling threshold) associated with the given user account; and
responsive to the averaged resource usage statistics being determined to be below the third set of threshold values for the given compared container, the instructions causing the processor to adjust the one or more resource allocations of the given container to a level between an elevated resource level and the level defined in the given user account.

33. The system of claim 32, wherein the instructions, when executed by the processor, further cause the processor to:
compare (i) an average of one or more resource usage statistics of each of the one or more containers to (ii) a second set of threshold values associated with the given user account that is associated with the given compared container; and
responsive to at least one of the average resource usage statistics of the one or more containers exceeding the second set of threshold values for the given compared container, migrate the given compared container to one or more containers operating on two or more host computing devices in accordance with a user-defined scaling rule (e.g., 1:2 or 1:4 or more).

34. The system of claim 33, wherein the instructions, when executed, cause the processor to:
retrieve attributes of the given compared container (e.g., CPU, memory, Block device/File system sizes);
create a snapshot of the given compared container, the given compared container hosting one or more web services, wherein the snapshot comprises an image of web service processes operating in the memory and kernel of the given compared container;
cause a new volume to be created at each new host computing device of the two or more host computing devices;
cause a new container to be created in each of the new volumes, wherein the new containers comprise the snapshot of the given compared container;
start one or more web service processes of the snapshot in each of the new containers;
stop the one or more web services of the given compared container; and
transfer traffic from (i) the one or more web services of the given compared container to (ii) one or more web services of the new containers.

35. The system of claim 34, wherein the instructions, when executed, further cause the processor to cause a firewall service to be added to the one or more web services of the new containers.

36. The system of claim 32, wherein the instructions, when executed, causes the processor to:
retrieve attributes of the given compared container (e.g., CPU, memory, Block device/File system sizes);
create a snapshot of the given compared container, the given compared container hosting one or more web services, wherein the snapshot comprises an image of processes operating in the memory and kernel of the given compared container;
cause a new container to be created in each of new volumes and a load balancing container to be created in a load balance volume; and
cause each of the new container to be linked to the load balancing containers, wherein the load balancing container is configured to monitor usage statistics among the new containers and adjust resource allocation of the new containers to be within a pre-defined threshold;
stop the one or more web services of the given compared container; and
transfer traffic from (i) the one or more web services of the given compared container to (ii) one or more web services of the new containers.

37. A non-transitory computer readable medium having instructions thereon, wherein the instructions, when executed by the processor, cause the processor to:
receive one or more resource usage statistics of one or more containers operating on the host computing device, the host computing device running an operating system kernel having one or more sets of isolated process groups (e.g., cgroups), each of the sets of isolated process groups corresponding to each of the one or more containers;
compare (i) an average of the one or more resource usage statistics of each of the one or more containers to (ii) a first set of threshold values associated with each given user account that is associated with the one or more compared containers; and
responsive to at least one of the averaged one or more resource usage statistics of the one or more containers exceeding the first set of threshold values for a given compared container from the one or more containers, adjust one or more resource allocations of the given compared container by a level defined for the given user account.

38. The computer readable medium of claim 17, wherein the adjustment of the one or more resource allocations of the given compared container comprises an update to the cgroup of the operating system kernel.

39. The computer readable medium of claim 37, wherein the level comprises an increment of resource units (e.g., CPU cores for processing resources, GBytes of RAM for memory resources, GBytes for network bandwidth, and/or GBytes of hard disk for data storage).

40. The computer readable medium of claim 37, wherein
subsequent to the first host computing device adjusting the one or more resource allocations of the given compared container to the elevated resource level, the host computing device is configured to compare, via a processor of the host computing device, (i) the average of the one or more resource usage statistics of each container operating on the host computing device to (ii) a third set of threshold values (e.g. down-scaling threshold) associated with the given user account; and
responsive to the averaged resource usage statistics being determined to be below the third set of threshold values for the given container, the host computing device being configured to adjust the one or more resource allocations of the given compared container to a level between an elevated resource level and the level defined in the given user account.
